(19) United States
(12) Patent Application Publication
(10) Pub. No.: US 2010/0228819 A1
(43) Pub. Date: Sep. 9, 2010

(54) SYSTEM AND METHOD FOR PERFORMANCE ACCELERATION, DATA PROTECTION, DISASTER RECOVERY AND ON-DEMAND SCALING OF COMPUTER APPLICATIONS

(75) Inventor: COACH WEI, CAMBRIDGE, MA (US)

Correspondence Address: AKC PATENTS, 215 GROVE ST., NEWTON, MA, 02466, US

(73) Assignee: YOTTAA INC, CAMBRIDGE, MA (US)

(21) Appl. No.: 12/717,297

(22) Filed: Mar. 4, 2010

Related U.S. Application Data
(60) Provisional application No. 61/157,567, filed on Mar. 5, 2009.

(51) Int. Cl. G06F 15/16

(52) U.S. Cl. 709/203; 709/248; 718/1

(57) ABSTRACT

A method for improving the performance and availability of a distributed application includes providing a distributed application configured to run on one or more origin server nodes located at an origin site. Next, providing a networked computing environment comprising one or more server nodes. The origin site and the computing environment are connected via a network. Next, providing replication means configured to replicate the distributed application and replicating the distributed application via the replication means thereby generating one or more replicas of the distributed application. Next, providing node management means configured to control any of the server nodes and then deploying the replicas of the distributed application to one or more server nodes of the computing environment via the node management means. Next, providing traffic management means configured to direct client requests to any of the server nodes and then directing client requests targeted to access the distributed application to optimal server nodes running the distributed application via the traffic management means. The optimal server nodes are selected among the origin server nodes and the computing environment server nodes based on certain metrics.

### CROSS REFERENCE TO RELATED CO-PENDING APPLICATIONS

This application claims the benefit of U.S. provisional application Ser. No. 61/157,567 filed on Mar. 5, 2010 and entitled SYSTEM AND METHOD FOR PERFORMANCE ACCELERATION, DATA PROTECTION, DISASTER RECOVERY AND ON-DEMAND SCALING OF COMPUTER APPLICATIONS, which is commonly assigned and the contents of which are expressly incorporated herein by reference.

### FIELD OF THE INVENTION

The present invention relates to distributed computing, data synchronization, business continuity and disaster recovery. More particularly, the invention relates to a novel method of achieving performance acceleration, on-demand scalability and business continuity for computer applications.

### BACKGROUND OF THE INVENTION

The advancement of computer networking has enabled computer programs to evolve from the early days' monolithic form that is used by one user at a time into distributed applications. A distributed application, running on two or more networked computers, is able to support multiple users at the same time. FIG. 1 shows the basic structure of a distributed application in a client-server architecture. The clients 100 send requests 110 via the network 140 to the server 150, and the server 150 sends responses 120 back to the clients 100 via the network 140. The same server is able to serve multiple concurrent clients.

Today, most applications are distributed. FIG. 2 shows the architecture of a typical web application. The client part of a web application runs inside a web browser 210 that interacts with the user. The server part of a web application runs on one or multiple computers, such as Web Server 250, Application Server 260, and Database Server 280. The server components typically reside in an infrastructure referred to as “host infrastructure” or “application infrastructure” 245.

In order for a web application to be able to serve a large number of clients, its host infrastructure must meet performance, scalability and availability requirements. “Performance” refers to the application's responsiveness to client interactions. A “client” may be a computing device or a human being operating a computing device. From a client perspective, performance is determined by the server processing time, the network time required to transmit the client request and server response and the client's capability to process the server response. Either long server processing time or long network delay time can result in poor performance.

“Scalability” refers to an application's capability to perform under increased load demand. Each client request consumes a certain amount of infrastructure capacity. For example, the server may need to do some computation (consuming server processing cycle), read from or write some data to a database (consuming storage and database processing cycle) or communicate with a third party (consuming processing cycle as well as bandwidth). As the number of clients grows, infrastructure capacity consumption grows linearly. When capacity is exhausted, performance can degrade significantly. Or worse, the application may become completely unavailable. With the exponential growth of the number of Internet users, it is now commonplace for popular web sites to serve millions of clients per day. With the exponential growth of the number of Internet users, load demand can easily overwhelm the capacity of a single server computer.

“Continuity”, often inter-exchangeable with terms such as “business continuity”, “disaster recovery” and “availability”, is about an application's ability to deliver continuous, uninterrupted service, in spite of unexpected events such as a natural disaster. Various events such as a virus, denial of service attack, hardware failure, fire, theft, and natural disasters like Hurricane Katrina can be devastating to an application, rendering it unavailable for an extended period of time, resulting in data loss and monetary damages.

An effective way to address performance, scalability and continuity concerns is to host a web application on multiple servers (server clustering) and load balance client requests among these servers (or sites). Load balancing spreads the load among multiple servers. If one server failed, the load balancing mechanism would direct traffic away from the failed server so that the site is still operational. FIG. 3 is an illustration of using multiple web servers, multiple application servers and multiple database servers to increase the capacity of the web application. Clustering is frequently used today for improving application scalability.

Another way for addressing performance, scalability and availability concerns is to replicate the entire application in two different data centers located in two different geographic locations (site mirroring). Site mirroring is a more advanced approach than server clustering because it replicates an entire application, including documents, code, data, web server software, application server software, database server software, to another geographic location, thereby creating two geographically separated sites mirroring each other. FIG. 4 shows an example of site mirroring. The different sites 450, 460 typically require some third party load balancing mechanism 440, heart beat mechanism 470 for health status check, and data synchronization between the sites. A hardware device called “Global Load Balancing Device” 440 performs load balancing among the multiple sites, shown in FIG. 4. For both server clustering and site mirroring, a variety of load balancing mechanisms have been developed. They all work fine in their specific context.

However, both server clustering and site mirroring have significant limitations. Both approaches provision a “fixed” amount of infrastructure capacity, while the load on a web application is not fixed. In reality, there is no “right” amount of infrastructure capacity to provision for a web application because the load on the application can swing from zero to millions of hits within a short period of time when there is a traffic spike. When under-provisioned, the application may perform poorly or even become unavailable. When over-provisioned, the over-provisioned capacity is wasted. To be conservative, a lot of web operators end up purchasing significantly more capacity than needed. It is common to see server utilization below 20% in a lot of data centers today, resulting in substantial capacity waste. Yet the application still goes under when traffic spikes happen. This is called as a “capacity dilemma” that happens every day. Furthermore, these traditional techniques are time consuming and expensive to set up and are equally time consuming and expensive to make changes. Events like natural disaster can cause an entire site to fail. Compared to server clustering, site mirroring provides availability even if one site completely failed. However, it is more complex and time consuming to set up and requires data synchronization between the two sites. Furthermore, it is technically challenging to make full use of both data centers. Typically, even if one took the pain to set up site mirroring, the second site is typically only used as a “standby”. In a “standby” situation, the second site is idle until the first site fails, resulting in significant capacity waste. Lastly, the set of global load balancing devices is a single point of failure.

A third approach for improving web performance is to use a Content Delivery Network (CDN) service. Companies like Akamai and Limelight Networks operate a global content delivery infrastructure comprising of tens of thousands of servers strategically placed across the globe. These servers cache web content (static documents) produced by their customers (content providers). When a user requests such content, a routing mechanism (typically based on Domain Name Server (DNS) techniques) would find an appropriate caching server to serve the request. By using content delivery service, users receive better content performance because content is delivered from an edge server that is closer to the user. Though content delivery networks can enhance performance and scalability, they are limited to static content. Web applications are dynamic. Responses dynamically generated from web applications cannot be cached. Web application scalability is still limited by its hosting infrastructure capacity. Further, CDN services do not enhance availability for web applications in general. If the hosting infrastructure goes down, the application will not be available. So though CDN services help improve performance and scalability in serving static content, they do not change the fact that the site's scalability and availability are limited by the site's infrastructure capacity.

A fourth approach for improving the performance of a computer application is to use an application acceleration apparatus (typically referred to as “accelerator”). Typical accelerators are hardware devices that have built-in support for traffic compression, TCP/IP optimization and caching. The principals of accelerator devices are the same as CDN, though CDN is implemented and provided as a network-based service. Accelerators reduce the network round trip time for requests and responses between the client and server by applying techniques such as traffic compression, caching and/or routing requests through optimized network routes. The accelerator approach is effective, but it only accelerates network performance. An application's performance is influenced by a variety of factors beyond network performance, such as server performance as well as client performance.

Neither CDN nor accelerator devices improve application scalability, which is still limited by its hosting infrastructure capacity. Further, CDN services do not enhance availability for web applications either. If the hosting infrastructure goes down, the application will not be available So though CDN services and hardware accelerator devices help improve performance in serving a certain type of content, they do not change the fact that the site's scalability and availability are limited by the site's infrastructure capacity. As for data protection, the current approaches are to use either a continuous data protection method or a periodical data backup method that copies data to a certain local storage disk or magnetic tapes, typically using special backup software system or hardware system. In order to store data remotely, the backup media (e.g., tape) need to be physically shipped to a different location.

Over the recent years, cloud computing has emerged as an efficient and more flexible way to do computing, shown in FIG. 4. According to Wikipedia, cloud computing “refers to the use of Internet-based (i.e. Cloud) computer technology for a variety of services. It is a style of computing in which dynamically scalable and often virtualized resources are provided as a service over the Internet. Users need not have knowledge of, expertise in, or control over the technology infrastructure ‘in the cloud’ that supports them”. The word “cloud” is a metaphor, based on how it is depicted in computer network diagrams, and is an abstraction for the complex infrastructure it conceals. In this document, we use the term “Cloud Computing” to refer to the utilization of a network-based computing infrastructure that includes many inter-connected computing nodes to provide a certain type of service, of which each node may employ technologies like virtualization and web services. The internal works of the cloud itself are concealed from the user point of view.

One of the enablers for cloud computing is virtualization. Wikipedia explains, “virtualization is a broad term that refers to the abstraction of computer resource”. It includes “Platform virtualization, which separates an operating system from the underlying platform resources”, “Resource virtualization, the virtualization of specific system resources, such as storage volumes, name spaces, and network resource” and so on. VMWare is a highly successful company that provides virtualization software to “virtualize” computer operating systems from the underlying hardware resources. Due to virtualization, one can use software to start, stop and manage “virtual machine” (VM) nodes 460, 470 in a computing environment 450, shown in FIG. 5. Each “virtual machine” behaves just like a regular computer from an external point of view. One can install software onto it, delete files from it and run programs on it, though the “virtual machine” itself is just a software program running on a “real” computer.

Another enabler for cloud computing is the availability of commodity hardware as well as the computing power of commodity hardware. For a few hundred dollars, one can acquire a computer that is more powerful than a machine that would have cost ten times more twenty years ago. Though an individual commodity machine itself may not be reliable, putting many of them together can produce an extremely reliable and powerful system. Amazon.com's Elastic Computing Cloud (EC2) is an example of a cloud computing environment that employs thousands of commodity machines with virtualization software to form an extremely powerful computing infrastructure.

By utilizing commodity hardware and virtualization, cloud computing can increase data center efficiency, enhance operational flexibility and reduce costs. Running a web application in a cloud environment has the potential to efficiently meet performance, scalability and availability objectives. For example, when there is a traffic increase that exceeded the current capacity, one can launch new server nodes to handle the increased traffic. If the current capacity exceeds the traffic demand by a certain threshold, one can shut down some of the server nodes to lower resource consumption. If some existing server nodes failed, one can launch new nodes and redirect traffic to the new nodes.

However, running web applications in a cloud computing environment like Amazon EC2 creates new requirements for traffic management and load balancing because of the frequent node stopping and starting. In the cases of server clustering and site mirroring, stopping a server or server failure are exceptions. The corresponding load balancing mechanisms are also designed to handle such occurrences as exceptions. In a cloud computing environment, server reboot and server shutdown are assumed to be common occurrences rather than exceptions. On one side, the assumption that individual nodes are not reliable is at the center of design for a cloud system due to its utilization of commodity hardware. On the other side, there are business reasons to start or stop nodes in order to increase resource utilization and reduce costs. Naturally, the traffic management and load balancing system required for a cloud computing environment must be responsive to node status changes.

Thus it would be advantageous to provide a method that improves the performance and availability of distributed applications.

### SUMMARY OF THE INVENTION

In general, in one aspect, the invention features a method for improving the performance and availability of a distributed application including the following. First, providing a distributed application configured to run on one or more origin server nodes located at an origin site. Next, providing a networked computing environment comprising one or more server nodes. The origin site and the computing environment are connected via a network. Next, providing replication means configured to replicate the distributed application and replicating the distributed application via the replication means thereby generating one or more replicas of the distributed application. Next, providing node management means configured to control any of the server nodes and then deploying the replicas of the distributed application to one or more server nodes of the computing environment via the node management means. Next, providing traffic management means configured to direct client requests to any of the server nodes and then directing client requests targeted to access the distributed application to optimal server nodes running the distributed application via the traffic management means. The optimal server nodes are selected among the origin server nodes and the computing environment server nodes based on certain metrics.

Implementations of this aspect of the invention may include one or more of the following. The networked computing environment may be a cloud computing environment. The networked computing environment may include virtual machines. The server nodes may be virtual machine nodes. The node management means control any of the server nodes by starting a new virtual machine node or by shutting down an existing virtual machine node. The replication means replicate the distributed application by generating virtual machine images of a machine on which the distributed application is running at the origin site. The replication means is further configured to copy resources of the distributed application. The resources may be application code, application data, or an operating environment in which the distributed application runs. The traffic management means comprises means for resolving a domain name of the distributed application via a Domain Name Server (DNS) The traffic management means performs traffic management by providing IP addresses of the optimal server nodes to clients. The traffic management means includes one or more hardware load balancers and/or one or more software load balancers. The traffic management means performs load balancing among the server nodes in the origin site and the computing environment. The certain metrics may be geographic proximity of the server nodes to the client or load condition of server node or network latency between a client and a server node. The method may further include providing data synchronization means configured to synchronize data among the server nodes. The replication means provides continuous replication of changes in the distributed application and the changes are deployed to server nodes where the distributed application has been previously deployed.

In general, in another aspect, the invention features a system for improving the performance and availability of a distributed application including a distributed application configured to run on one or more origin server nodes located at an origin site, a networked computing environment comprising one or more server nodes, replication means, node management means and traffic management means. The origin site and the computing environment are connected via a network. The replication means replicate the distributed application and thereby generate one or more replicas of the distributed application. The node management means control any of the server nodes and they deploy the replicas of the distributed application to one or more server nodes of the computing environment. The traffic management means direct client requests targeted to access the distributed application to optimal server nodes running the distributed application. The optimal server nodes are selected among the origin server nodes and the computing environment server nodes based on certain metrics.

Among the advantages of the invention may be one or more of the following. The invention provides a novel method for application operators (“application operator” refers to an individual or an organization who owns an application) to deliver their applications over a network such as the Internet. Instead of relying on a fixed deployment infrastructure, the invention uses commodity hardware to form a global computing infrastructure, an Application Delivery Network (ADN), which deploys applications intelligently to optimal locations and automates the administration tasks to achieve performance, scalability and availability objectives. The invention accelerates application performance by running the application at optimal nodes over the network, accelerating both network performance and server performance by picking a responsive server node that is also close to the client. The invention also automatically scales up and down the infrastructure capacity in response to the load, delivering on-demand scalability with efficient resource utilization. The invention also provides a cost-effective and easy-to-manage business continuity solution by dramatically reducing the cost and complexity in implementing “site mirroring”, and provides automatic load balancing/failover among a plurality of server nodes distributed across multiple sites.

Unlike CDN services which replicate static content and cache them at edge nodes over a global content delivery network for faster delivery, the ADN performs edge computing by replicating an entire application, including static content, code, data, configuration and associated software environments and pushing such replica to optimal edge nodes for computing. In other words, instead of doing edge caching like CDN, the subject invention performs edge computing. The immediate benefit of edge computing is that it accelerates not only static content but also dynamic content. The subject invention fundamentally solves the capacity dilemma by dynamically adjusting infrastructure capacity to match the demand. Further, even if one server or one data center failed, the application continues to deliver uninterrupted service because the Application Delivery Network automatically routes requests to replicas located at other parts of the network.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is block diagram of a distributed application in a client-server architecture (static web site);

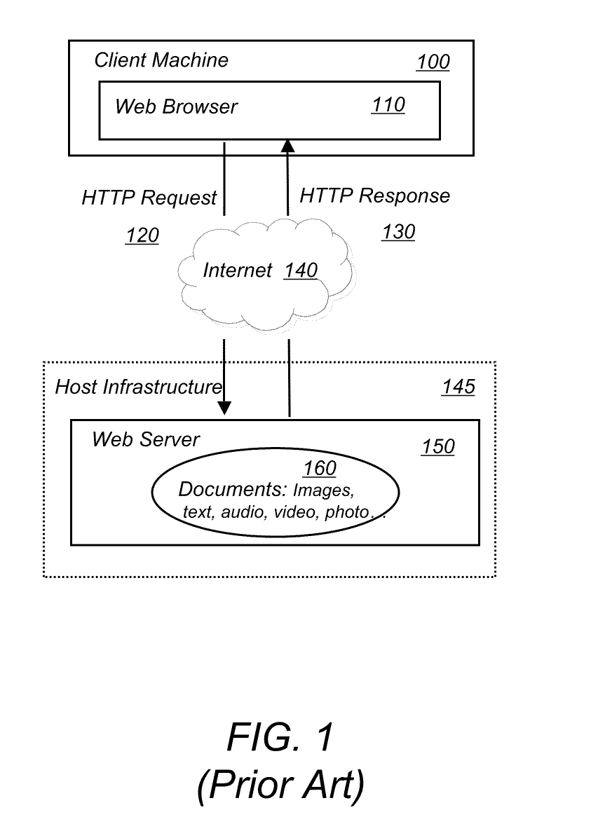

FIG. 2 is block diagram of a typical web application (“dynamic web site”);

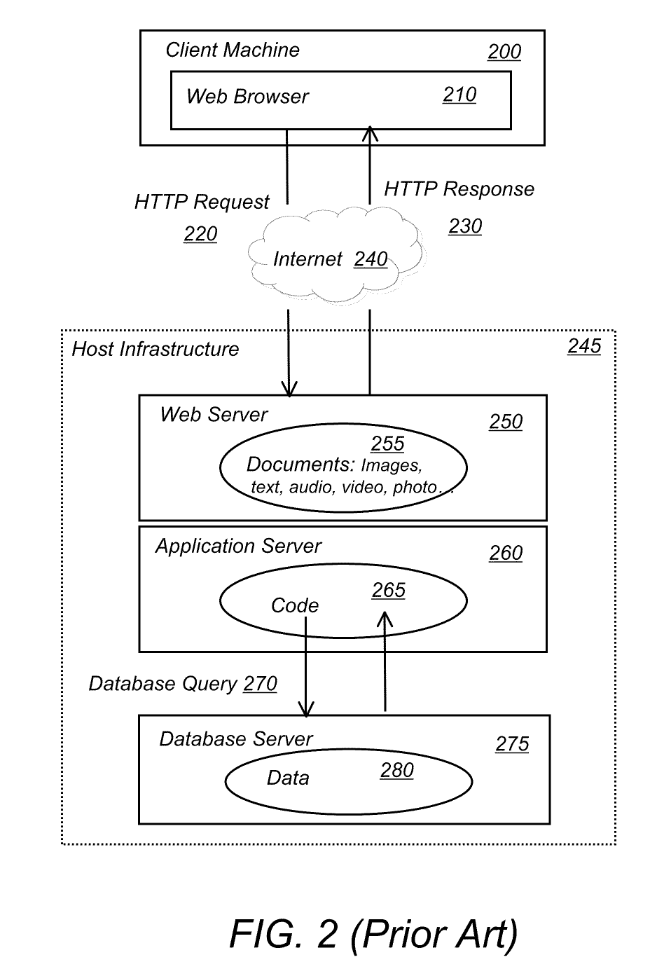

FIG. 3 is a block diagram of a cluster computing environment (prior art);

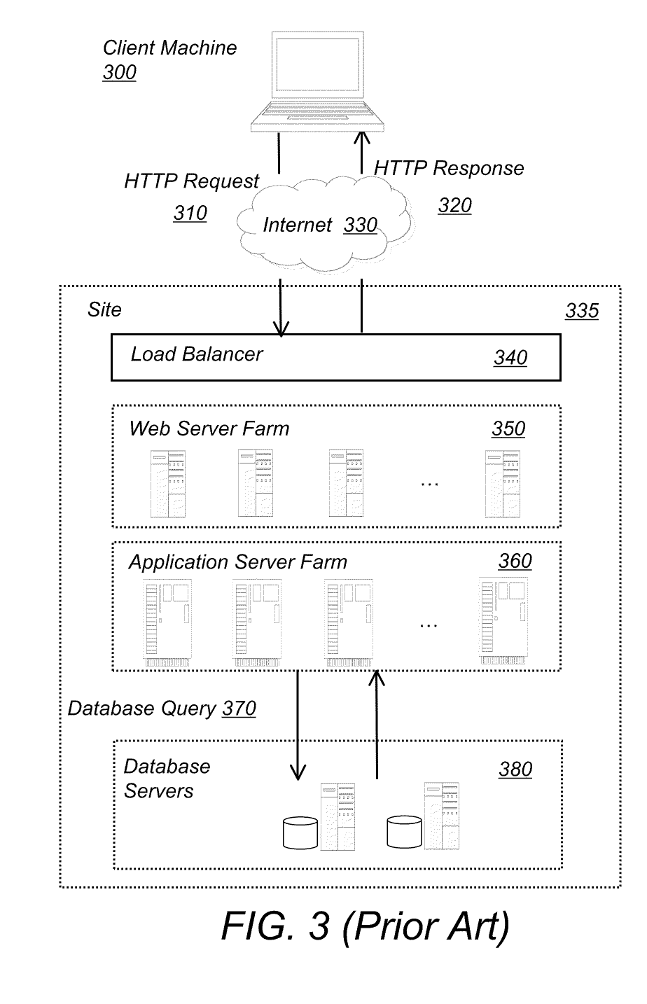

FIG. 3A is a schematic diagram of a cloud computing environment;

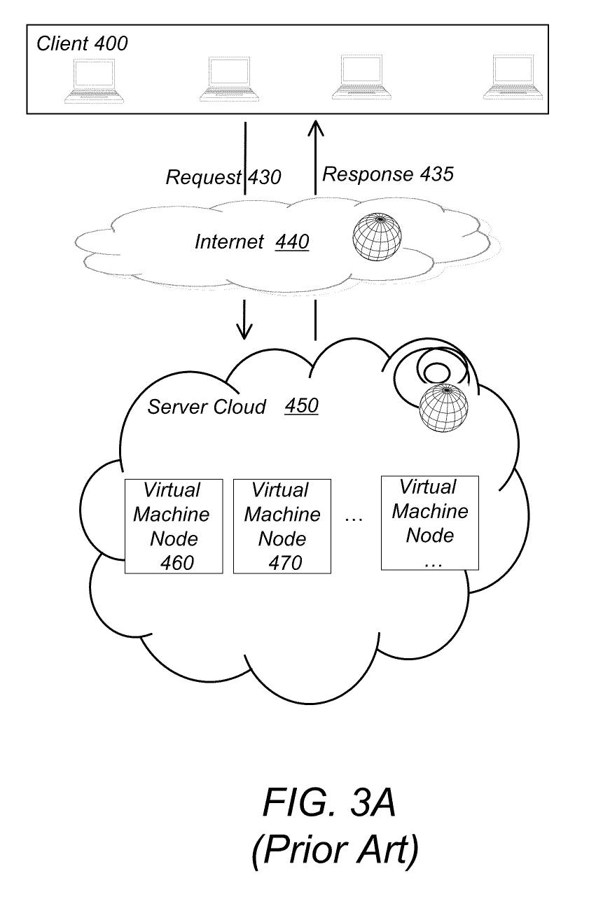

FIG. 4 is a schematic diagram of site-mirrored computing environment (prior art);

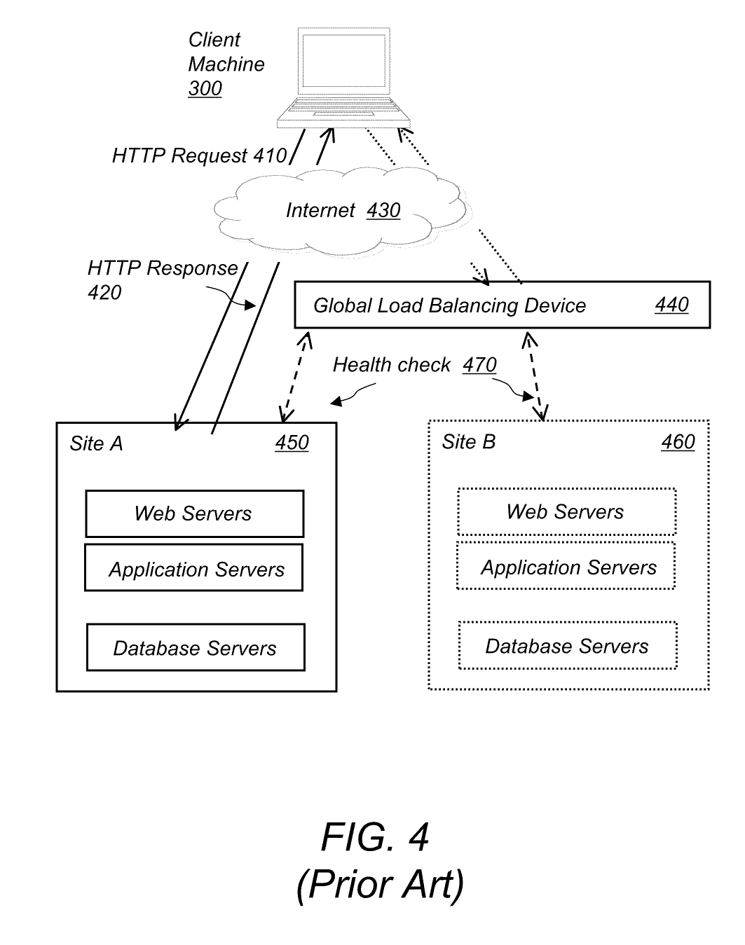

FIG. 5 shows an Application Delivery Network (ADN) of this invention;

FIG. 6 is a block diagram of a 3-tiered web application running on an application delivery network;

FIG. 7 is a block diagram showing the use of an ADN in managing a cloud computing environment;

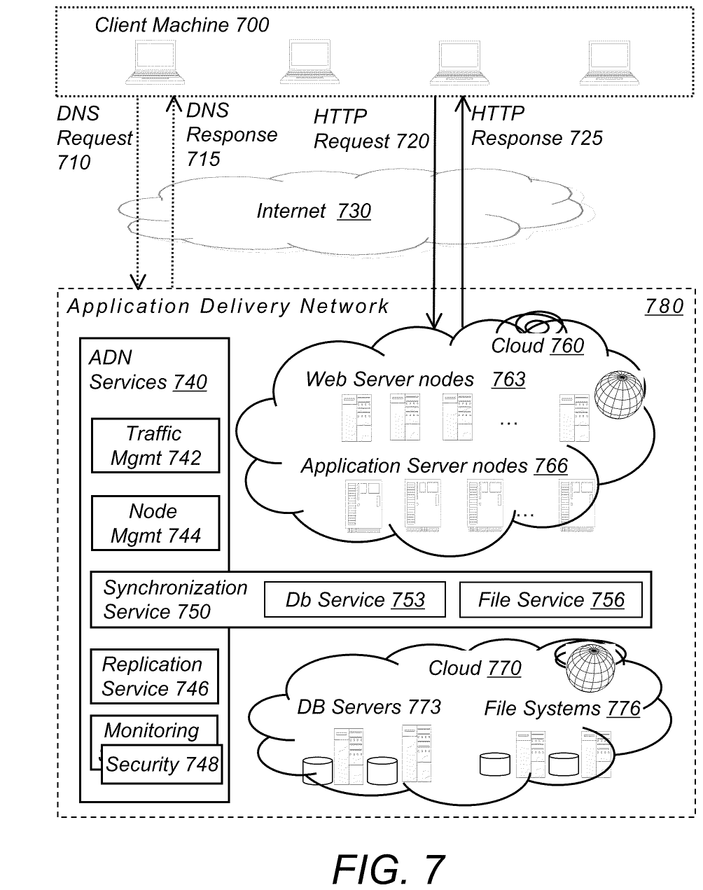

FIG. 8 is a block diagram showing running the ADN services in a cloud environment;

FIG. 9 is a block diagram of a business continuity setup in an ADN managed cloud computing environment;

FIG. 10 is a block diagram of automatic failover in the business continuity setup of FIG. 9;

FIG. 11 is a flow diagram showing the use of ADN in providing global application delivery and performance acceleration;

FIG. 12 is a block diagram showing the use of ADN in providing on-demand scaling to applications;

FIG. 13 is a schematic diagram of an embodiment called “Yottaa” of the subject invention;

FIG. 14 is a flow diagram of the DNS lookup process in Yottaa of FIG. 13;

FIG. 15 is a block diagram of a Yottaa Traffic Management node;

FIG. 16 is a flow diagram of the life cycle of a Yottaa Traffic Management node;

FIG. 17 is a block diagram of a Yottaa Manager node;

FIG. 18 is a flow diagram of the life cycle of a Yottaa Manager node;

FIG. 19 is a block diagram of a Yottaa Monitor node;

FIG. 20 is a block diagram Node Controller module;

FIG. 21 is a flow diagram of the functions of the Node Controller module;

FIG. 22 is a schematic diagram of a data synchronization system of this invention;

FIG. 23 is a block diagram of a data synchronization engine;

FIG. 24 is a schematic diagram of another embodiment of the data synchronization system of this invention;

FIG. 25 is a schematic diagram of a replication system of this invention;

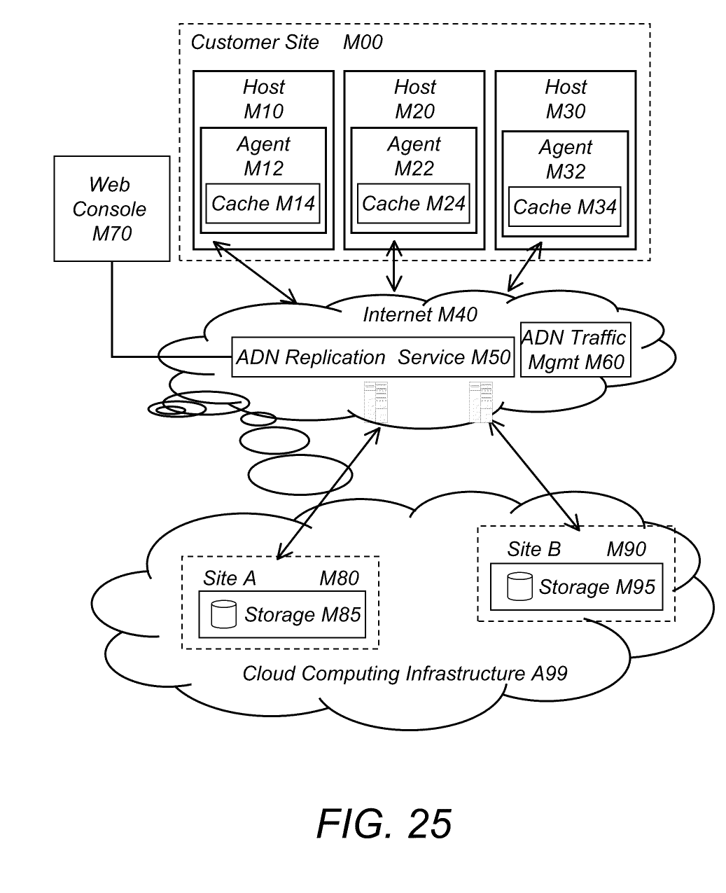

FIG. 26 shows a schematic diagram of using the invention of FIG. 5 to deliver a web performance service over the Internet to web site operators;

FIG. 27 is a schematic diagram of data protection, data archiving and data back up system of the present invention;

FIG. 28 shows the architectural function blocks in the data protection and archiving system of FIG. 27; and

FIG. 29 is a flow diagram of a data protection and archiving method using the system of FIG. 27.

### DETAILED DESCRIPTION OF THE INVENTION

The present invention creates a scalable, fault tolerant system called “Application Delivery Network (ADN)”. An Application Delivery Network automatically replicates applications, intelligently deploys them to edge nodes to achieve optimal performance for both static and dynamic content, dynamically adjusts infrastructure capacity to match application load demand, and automatically recovers from node failure, with the net result of providing performance acceleration, unlimited scalability and non-stop continuity to applications.

A typical embodiment of the subject invention is to set up an “Application Delivery Network (ADN)” as an Internet delivered service. The problem that ADN solves is the dilemma between performance, scalability, availability, infrastructure capacity and cost. The benefits that ADN brings include performance acceleration, automatic scaling, edge computing, load balancing, backup, replication, data protection and archiving, continuity, and resource utilization efficiency

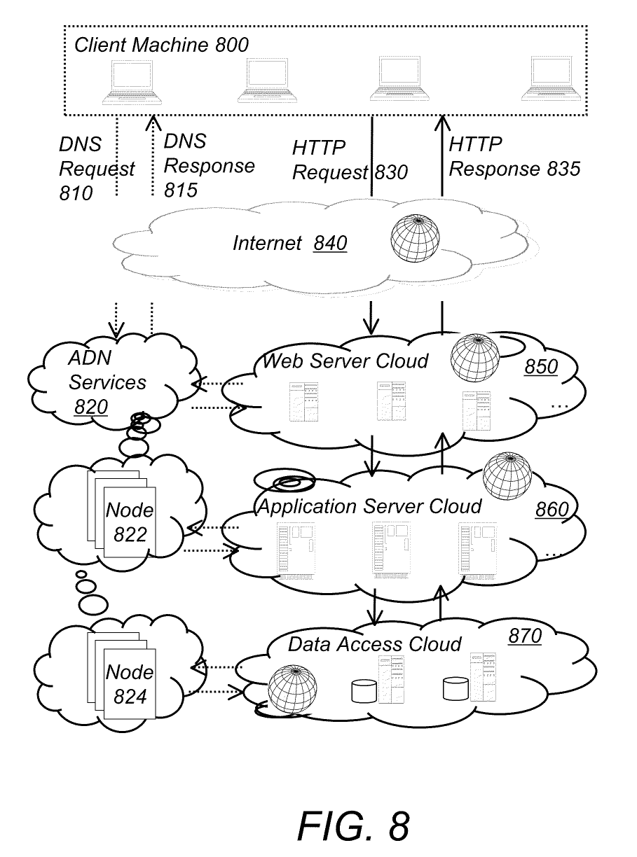

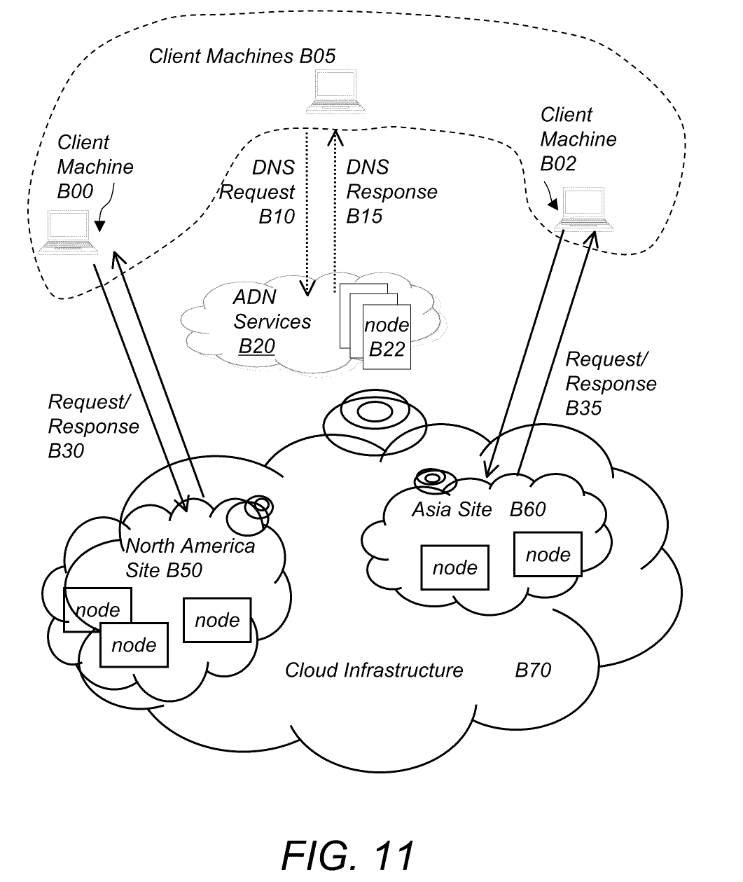

Referring to FIG. 8, an Application Delivery Network 820 is hosted in a cloud computing environment that includes web server cloud 850, application server cloud 860, and data access cloud 870. Each cloud itself maybe distributed across multiple data centers. The ADN service 820 dynamically launches and shuts down server instances in response to the load demand. FIG. 11 shows another embodiment of an Application Delivery Network. In this embodiment the ADN B20 distributes nodes across multiple data centers (i.e., North America site B50, Asia site B60) so that application disruption is prevented even if an entire data center fails. New nodes are launched in response to increased traffic demand and brought down when traffic spikes go away. As a result the ADN delivers performance acceleration of an application, on-demand scalability and non-stop business continuity, with “always the right amount of capacity”.

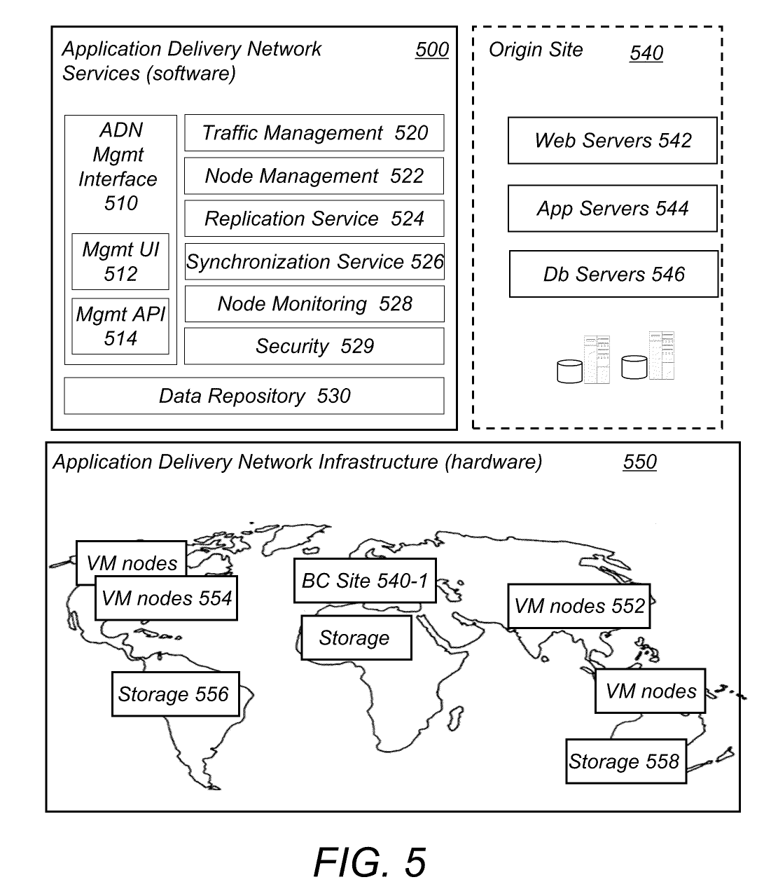

Referring to FIG. 5, an ADN contains a computing infrastructure layer (hardware) 550 and a service layer (software) 500. ADN computing infrastructure 550 refers to the physical infrastructure that the ADN uses to deploy and run applications. This computing infrastructure contains computing resources (typically server computers), connectivity resources (network devices and network connections), and storage resources, among others. This computing infrastructure is contained within a data center, a few data centers, or deployed globally across strategic locations for better geographic coverage. For most implementations of the subject invention, a virtualization layer is deployed to the physical infrastructure to enable resource pooling as well as manageability. Further, the infrastructure is either a cloud computing environment itself, or it contains a cloud computing environment. The cloud computing environment is where the system typically launches, or shuts down virtual machines for various applications.

The ADN service layer 500 is the “brain” for the ADN. It monitors and manages all nodes in the network, dynamically shuts them down or starts them up, deploys and runs applications to optimal locations, scales up or scales down an application's infrastructure capacity according to its demand, replicates applications and data across the network for data protection and business continuity and to enhance scalability.

The ADN service layer 500 contains the following function services.
1. Traffic Management 520: this module is responsible for routing client requests to server nodes. It provides load balancing as well as automatic failover support for distributed applications. When a client tries to access an application's server infrastructure, the traffic management module directs the client to an “optimal” server node (when there are multiple server nodes). “Optimal” is determined by the system's routing policy, for example, geographic proximity, server load, session stickiness, or a combination of a few factors. When a server node or a data center is detected to have failed, the traffic management module directs client requests to the remaining server nodes. Session stickiness, also known as “IP address persistence” or “server affinity” in the art, means that different requests from the same client session will always be routed to the same server in a multi-server environment. “Session stickiness” is required for a variety of web applications to function correctly. In one embodiment the traffic management module 520 uses a DNS-based approach, as disclosed in co-pending patent applications U.S. Ser. No. 12/714,486, U.S. Ser. No. 12/714,480, and U.S. Ser. No. 12/713,042, the entire contents of which are incorporated herewith.
2. Node Management 522: this module manages server nodes in response to load demand and performance changes, such as starting new nodes, shutting down existing nodes, recover from failed nodes, among others. Most of the time, the nodes under management are “virtual machine” (VM) nodes, but they can also be physical nodes.
3. Replication Service 524: This module is responsible for replicating an application and its associated data from its origin node to the ADN. The module can be configured to provide a “backup” service that backs up certain files or data from a certain set of nodes periodically to a certain destination over the ADN. The module can be also configured to provide “continuous data protection” for a certain data sources by replicating such data and changes to the ADN's data repository, which can be rolled back to a certain point of time if necessary. Further, this module is also to take a “snapshot” of an application including its environments, creating a “virtual machine” image that can be stored over the ADN and used to launch or restore the application on other nodes.
4. Synchronization Service 526: This module is responsible for synchronizing data operations among multiple database instances or file systems. Changes made to one instance will be immediately propagated to other instances over the network, ensuring data coherency among multiple servers. With the synchronization service, one can scale out database servers by just adding more server nodes.
5. Node Monitoring 528: this service monitors server nodes and collects performance metrics data. Such data are important input to the traffic management module in selecting “optimal” nodes to serve client requests, and determining whether certain nodes have failed.
6. ADN Management Interface 510: this service enables system administrators to manage the ADN. This service also allows a third party (e.g. an ADN customer) to configure the ADN for a specific application. System management is available via a user interface (UI) 512 as well as set of Application Programming Interfaces (API) 514 that can be called by software applications directly. A customer can configure the system by specifying required parameters, routing policy, scaling options, backup and disaster recovery options, and DNS entries, among others, via the management interface 510.
7. Security Service 529: this module provides the necessary security service to the ADN network so that access to certain resources are granted only after proper authentication and authorization.
8. Data Repository 530: this service contains common data shared among a set of nodes in the ADN, and provides access to such data.

The system is typically delivered as a network-based service. To use the service, a customer goes to a web portal to configure the system for a certain application. In doing so, the customer fills in required data such as information about the current data center (if the application is in production already), account information, the type of service requested, parameters for the requested services, and so on. When the system is activated to provide services to the application, it configures the requested services according to the configuration data, schedules necessary replication and synchronization tasks if required, and waits for client requests. When a client request is received, the system uses its traffic management module to select an optimal node to serve the client request. According to data received from the monitoring service, the system performs load balancing and failover when necessary. Further, in response to traffic demands and server load conditions, the system dynamically launches new nodes and spreads load to such new nodes, or shuts down some existing nodes.

For example, if the requested service is “business continuity and disaster recovery”, the customer is first instructed to enable the “Replication Service” 524 that replicates the “origin site” 540 to the ADN, as shown in FIG. 5. Once the replication is finished, the system may launch a replica over the ADN infrastructure as a “2nd site” BC 540-1 and starts synchronization between the two sites. Further, the system's traffic management module manages client requests. If the “2nd site” is configured to be a “hot” site, client requests will be load balanced between the two sites. If the 2nd site is configured as a “warm” site, it will be up but does not receive client requests until the origin site failed. Once such failure is detected, the traffic management service immediately redirects client requests to the “2nd site”, avoiding service disruption. The 2nd site may also be configured as “cold”, which is only launched after the origin site has failed. In a “cold” site configuration, there is a service interruption after the origin site failure and before the “cold” site is up and running The phrase “2nd site” is used here instead of the phrase “mirrored site” because the 2^{nd} site does not have to mirror the origin site in an ADN system. ADN is able to launch nodes on-demand. The 2^{nd} site only needs to have a few nodes running to keep it “hot” or “warm”, or may not even have nodes running at all (“cold”). This capability eliminates the major barriers of “site mirroring”, i.e., the significant up front capital requirements, the complexity and time commitment required in setting up and maintaining a 2^{nd} data center.

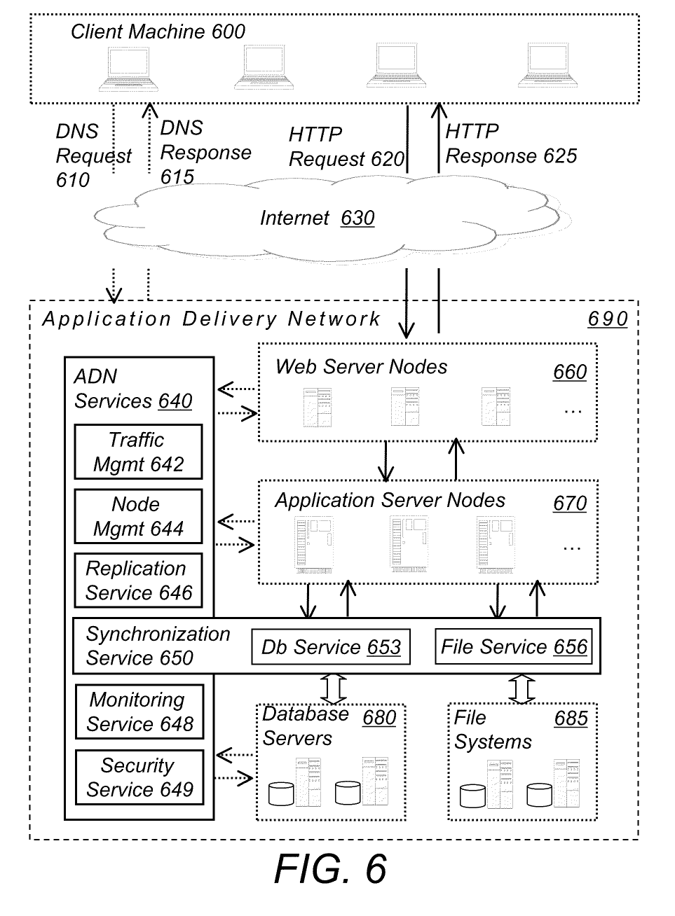

FIG. 6 shows the implementation of the ADN 690 to a 3-tiered web application. In this embodiment, the web server nodes 660, the application server nodes 670, the database servers 680 and file systems 685 of a web application are deployed onto different server nodes. These nodes can be physical machines running inside a customer's data center, or virtual machines running inside the Application Delivery Network, or a mixture of both. In this diagram, a Domain Name Server (DNS) based approach is used for traffic management. When client machine 600 wants to access the application, it sends a DNS request 610 to the network. The traffic management module 642 receives the DNS request, selects an “optimal” node from the plurality of server nodes for this application according to a certain routing policy (such as selecting a node that is geographically closer to the client), and returns the Internet Protocol (IP) address 615 of the selected node to the client. Client 600 then makes an HTTP request 620 to the server node. Given that this is an HTTP request, it is processed by one of the web servers 660 and may propagate to an application server node among the application server nodes 670. The application server node runs the application's business logic, which may requires database access or file system access. In this particular embodiment, access to persistent resources (e.g. database 680 or file system 685) are configured to go through the synchronization service 650. In particular, synchronization service 650 contains database service 653 that synchronizes a plurality of databases over a distributed network, as well as file service 656 that synchronizes file operations over multiple file systems across the network. In one embodiment, the synchronization service 650 uses a “read from one and write to all” strategy in accessing replicated persistent resources. When the operation is a “read” operation, one “read” operation from one resource or even better, from local cache, is sufficient. The synchronization service 650 typically contains a local cache that is able to serve “read” operation directly from local cache for performance reasons. If it is a “write” operation, the synchronization service 650 makes sure all target persistent resources are “written” to so that they are synchronized. Upon the completion of database access or file system access, the application server node creates a response and eventually HTTP response 625 is sent to the client.

One embodiment of the present invention provides a system and a method for application performance acceleration. Once an application is deployed onto an Application Delivery Network, the system automatically replicates the application to geographically distributed locations. When a client issues a request, the system automatically selects an optimal server node to serve the request. “Optimal” is defined by the system's routing policy, such as geographic proximity, server load or a combination of a few factors. Further, the system performs load balancing service among the plurality of nodes the application is running on so that load is optimally distributed. Because client requests are served from one of the “best” available nodes that are geographically close to the client, the system is able to accelerate application performance by reducing both network time as well as server processing time.

FIG. 11 illustrates an embodiment that provides global application delivery, performance acceleration, load balancing, and failover services to geographically distributed clients. Upon activation, the ADN B20 replicates the application and deploys it to selected locations distributed globally, such as North America site B50 and Asia site B60. Further, when client requests B30 are received, the ADN automatically selects the “closest” server node to the client BOO, an edge node in North America site B50, to serve the request. Performance is enhanced not only because the selected server node is “closer” to the client, but also because computation happens on a performing edge node. Similarly, client B02 located in Asia is served by an edge node selected from Asia Site B60.

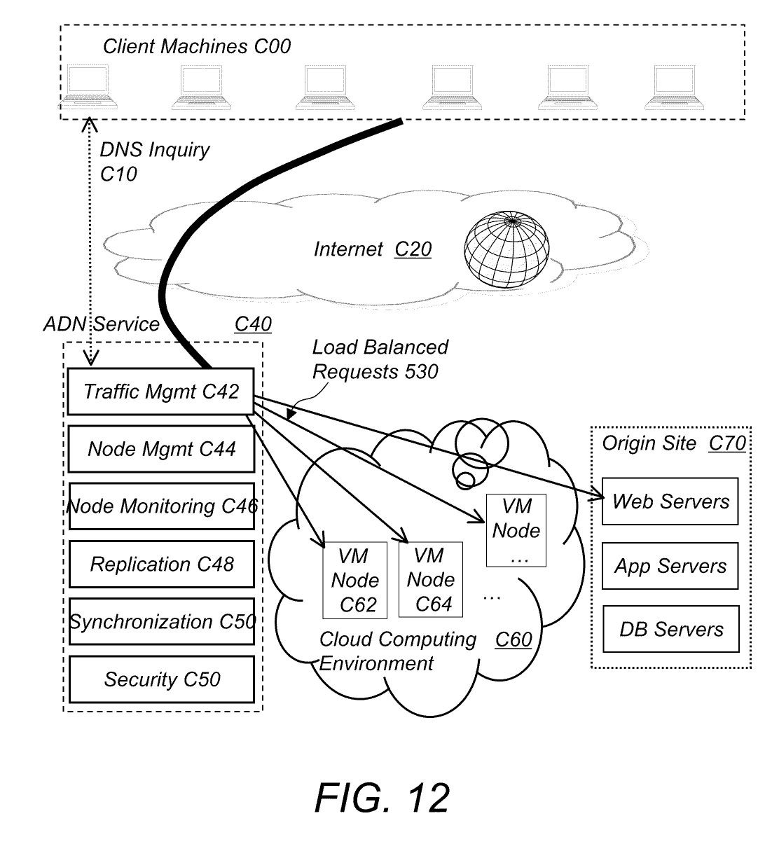

Another embodiment of the present invention provides a system and a method for automatic scaling an application. Unlike traditional scaling solutions such as clustering, the subject system constantly monitors the load demand for the application and the performance of server nodes. When it detects traffic spikes or server nodes under stress, it automatically launches new server nodes and spreads load to the new server nodes. When load demand decreases to a certain threshold, it shuts down some of the server nodes to eliminate capacity waste. As a result, the system delivers both qualify of service and efficient resource utilization. FIG. 12 illustrates how ADN C40 scales out an application (“scale out” means improving scalability by adding more nodes). The application is running on origin site C70, which has a certain capacity. All applications have their own “origin sites”, being either some facility over a customer's internal Local Area Network (LAN), or some facility over some hosted data centers that the customer either owns or “rents”. Each origin site has a certain capacity and can serve up to a certain amount of client requests. If traffic demand exceeds such capacity, performance suffers. In order to handle such problems, web operators have to add more capacity to the infrastructure, which can be expensive. Using the subject invention, ADN Service C40 monitors traffic demand and server load conditions of origin site C70. When necessary, ADN Service C40 launches new server nodes in a cloud computing environment C60. Such new nodes are typically virtual machine nodes, such as C62 and C64. Further, the system's traffic management service automatically spreads client requests to the new nodes. Load is balanced among the server nodes at origin site C70 as well as those newly launched in cloud environment C60. When traffic demand decreases below a certain threshold, ADN service C40 shuts down the virtual machine nodes in the cloud environments, and all requests are routed to origin site C70.

The benefits of the on-demand scaling system are many: First, the system eliminates expensive up front capital investment in setting up a large number of servers and infrastructure. It allows a business model that customers pay for what they use. Second, the system provides on-demand scalability, guarantees the application's capability to handle traffic spikes. Third, the system allows customers to own and control their own infrastructure and does not disrupt existing operations. A lot of customers want to have control of their application and infrastructure for various reasons, such as convenience, reliability and accountability, and would not want to have the infrastructure owned by some third party. The subject invention allows them to own and manage their own infrastructure “Origin Site C70”, without any disruption to their current operations.

In another embodiment, the present invention provides a system and a method for application staging and testing. In a typical development environment, developers need to set up a production environment as well as a testing/staging environment. Setting two environments is time consuming and not cost effective because the testing/staging environment is not used for production. The subject invention provides a means to replicate a production system in a cloud computing environment. The replica system can be used for staging and testing. By setting up a replica system in a cloud computing environment, developers can perform staging and testing as usual. However, once the staging and testing work finishes, the replica system in the cloud environment can be released and disposed, resulting in much more efficient resource utilization and significant cost savings.

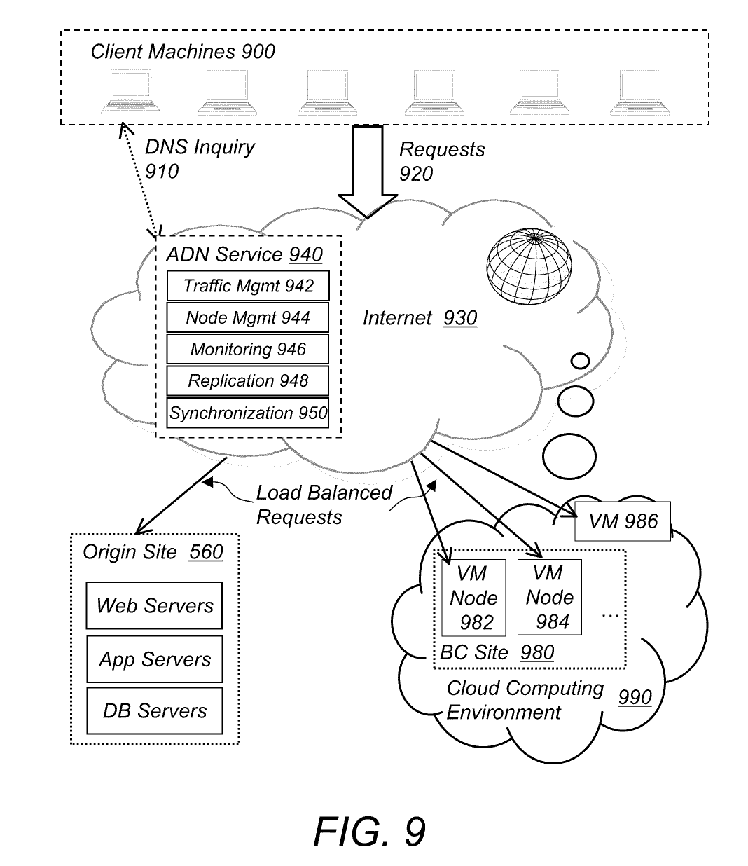

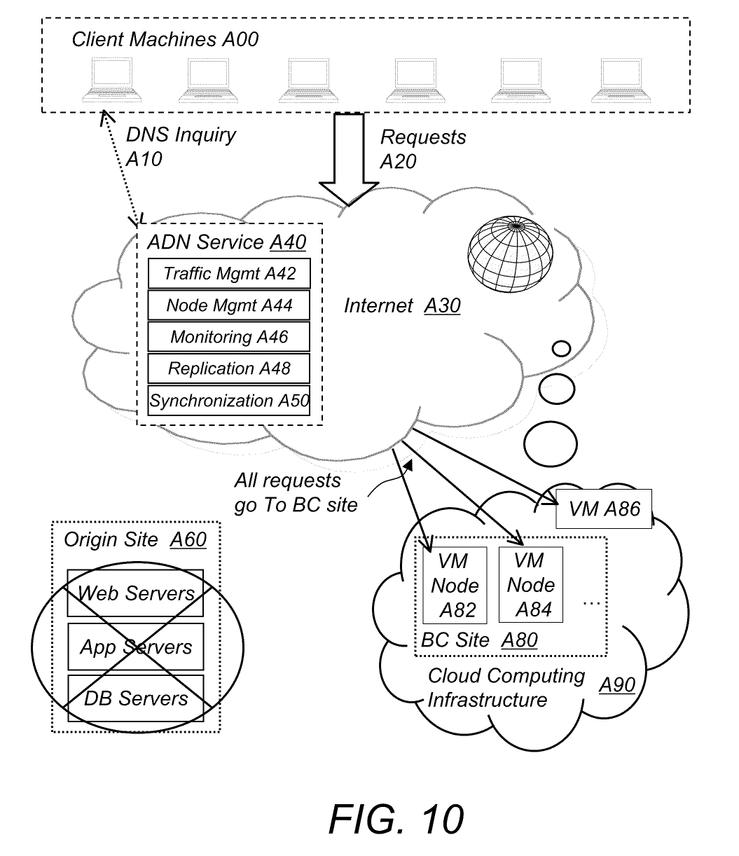

Yet another embodiment of the subject invention provides a novel system and method for business continuity and disaster recovery, as was mentioned above. Unlike CDN that replicates only documents, the system replicates an entire application, including documents, code, data, web server software, application server software and database server software, among others, to its distributed network and performs synchronization in real-time when necessary. By replicating the entire application from its origin site to multiple geographically distributed server nodes, failure of one data center will not cause service disruption or data loss. Further, the system automatically performs load balancing among server nodes, if the replicated server nodes are allowed to receive client requests as “hot replica”, the system detects the failure and automatically routes requests to other nodes when a certain node failed. So even if a disaster happens that destroyed an entire data center, the application and its data are still available from other nodes located at other regions. FIG. 9 shows an example of using ADN 940 to provide business continuity (BC). The application is deployed at “origin site 560”. This “origin site” may be the customer's own data center, or an environment within the customer's internal local area network (LAN). Upon activating ADN services, ADN replicates the application from origin site 560 to a cloud computing environment 990. Per customer's configuration, a business continuity site 980 is launched and actively participates in serving client requests. ADN balances client requests 920 between the “origin site” and the “BC site”. Furthermore, as shown in FIG. 10, when origin site A60 fails, the ADN A40 automatically directs all requests to BC site A80.

Depending on the customer's configuration, the system may create more than one BC sites. Further, depending on how the customer configured the service, some of the BC sites may be configured to be “cold”, “warm” or “hot”. “Hot” means that the servers at the BC site are running and are actively participating serving client requests; “Warm” means that the servers at the BC site are running but are not receiving client requests unless a certain conditions are met (for example, the load condition at the origin site exceeds a certain threshold). “Cold” means that the servers are not running and will only be launched upon a certain event (such as failure of the origin site). For example, if it is acceptable to have a 30-minute service disruption, the customer can configure the “BC site” to be “cold”. On the other side, if service disruption is not acceptable, the customer can configure the “BC site” to be “hot”. In FIG. 9, the BC site 980 is configured to be “hot” and is serving client requests together with the “origin site”. ADN service 940 automatically balances requests to both the origin site 560 and BC site 980. As the application is running on both sites, ADN service 940 may also perform data synchronization and replications if such are required for the application. If one site failed, data and the application itself are still available at the other site.

Referring to FIG. 10, the origin site A60 failed and the system detects the failure and automatically routes all client requests to BC site A80. During the process, clients receive continued service from the application and no data loss occurred either. In doing so, the system may launch new VM nodes at BC site A80 to handle the increased traffic. The customer can use the replica at BC site A80 to restore the origin site A60 if needed. When origin site A60 is running and back online, ADN service A40 spreads traffic to it. Again, the traffic is split among two sites and everything is restored back to the setup before the failure. Neither application disruption nor data loss occurred during the process.

The benefits of the above mentioned Business Continuity (BC) service of the subject invention are numerous. Prior art business continuity solutions typically require setting a “mirror site” that requires significant up front capital and time investment, and significant on-going maintenance. Unlike the prior art solutions, the subject invention utilizes a virtual infrastructure with cloud computing to provide an “on-demand mirror site” that requires no up front capital, easy to set up and easy to maintain. Customers pay for what they use. Customers can still own and manage their own infrastructure if preferred. The system does not interrupt customer's existing operations.

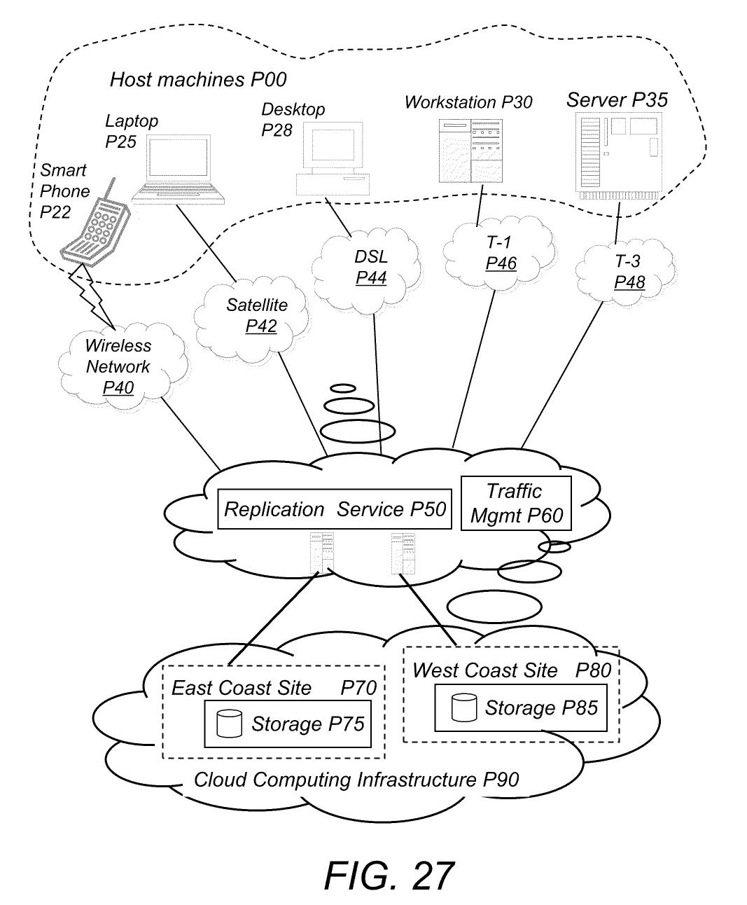

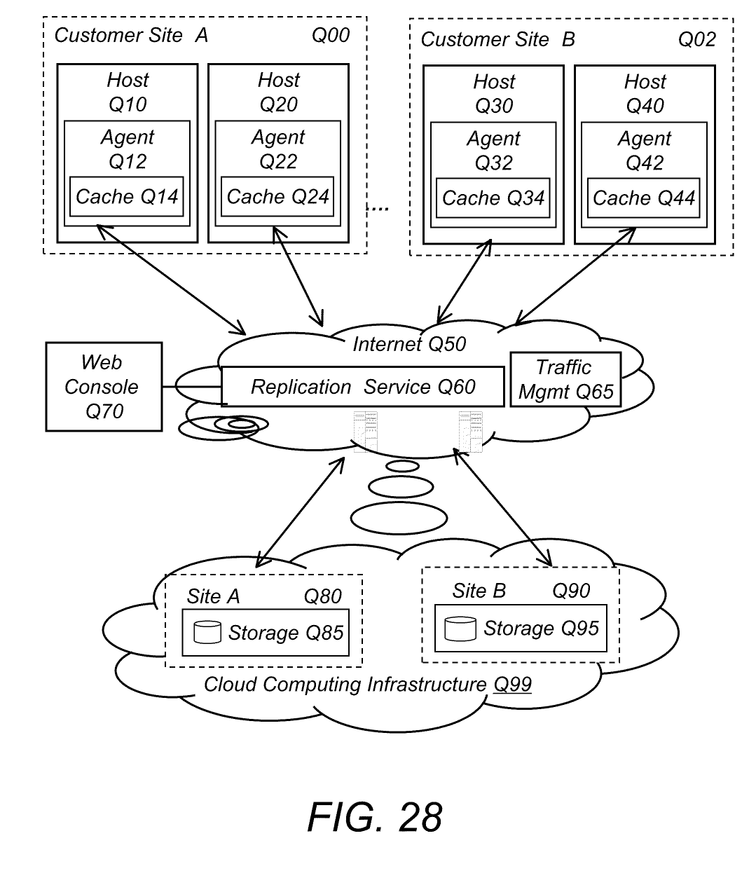

Yet another embodiment of the present invention provides a system and a method for data protection and archiving, as shown in FIG. 27 and FIG. 28. Unlike traditional data protection methods such as backing up data to local disks or tapes, the subject system automatically stores data to a cloud computing environment. Further, unlike traditional data protection methods that require special hardware or software setup, the subject invention is provided as a network-delivered service. It requires only downloading a small piece of software called “replication agent” to the target machine and specifying a few replication options. There is no hardware or software purchase involved. When data is changed, it automatically sends the changes to the cloud environment. In doing so, the system utilizes the traffic management service to select an optimal node in the system to perform replication service, thus minimizing network delay and maximizing replication performance.

Referring to FIG. 27, a data protection and archiving system includes a variety of host machines such as server P35, workstation P30, desktop P28, laptop P25 and smart phone P22, connected to the ADN via a variety of network connections such as T3, T1, DSL, cable modem, satellite and wireless connections. The system replicates data from the host machines via the network connections and stores them in cloud infrastructure P90. The replica may be stored at multiple locations to improve reliability, such as East Coast Site P70 and West Coast Site P80. Referring to FIG. 28, a piece of software called “agent” is downloaded to each host computer, such as Q12, Q22, Q32 and Q42 in FIG. 28. The agent collects initial data from the host computer and sends them to the ADN over network connections. ADN stores the initial data in a cloud environment Q99. Agent also monitors on-going changes for the replicated resources. When a change event occurs, the agent collects the change (delta), and either sends the delta to the ADN immediately (“continuous data protection”), or stores the delta in a local cache and sends a group of them at once at specific intervals (“periodical data protection”). The system also provides a web console Q70 for customers to configure the behavior of the system.

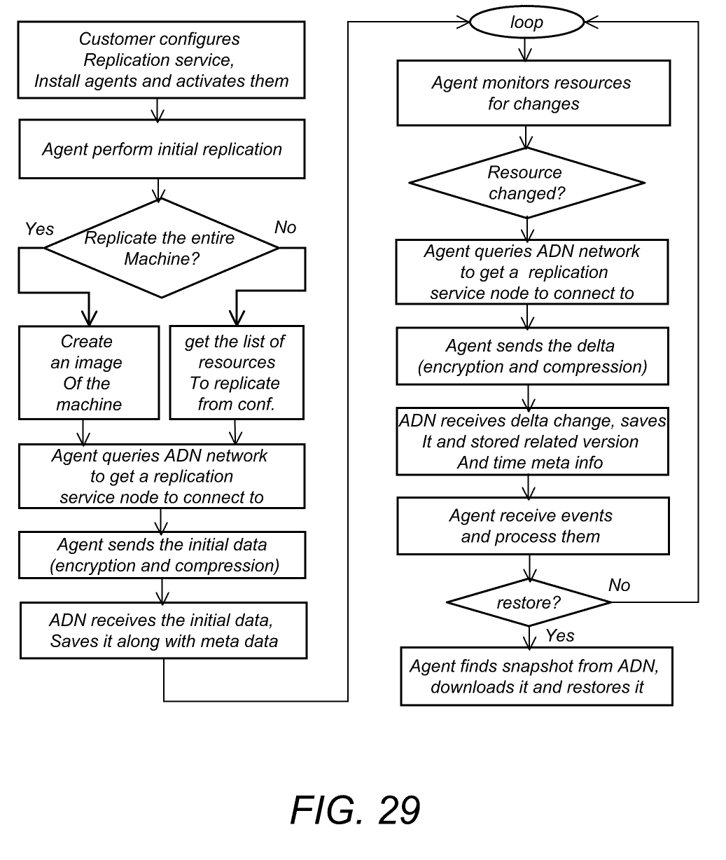

FIG. 29 shows the replication workflow of the above mentioned data protection and archiving system. A customer starts by configuring and setting up the replication service, typically via the web console. The setup process specifies whether continuous data protection or periodical data protection is needed, number of replicas, preferred locations of the replicas, user account information, and optionally purchase information, among others. Then the customer is instructed to download, install and run agent software on each host computer. When an agent starts up for the first time, it uses local information as well as data received from the ADN to determine whether this is the first time replication. If so, it checks replication configuration to see whether the entire machine or only some resources on the machine need to be replicated. If the entire machine needs to be replicated, it creates a machine image that captures all the files, resources, software and data on this machine. If only a list of resources need to be replicated, it creates the list. Then the agent sends the data to the ADN. In doing so, the agent request is directed to an “optimal” replication service node in the ADN by the ADN's traffic management module. Once the replication service node receives the data, it saves the data along with associated metadata, such as user information, account information, time and date, among others. Encryption and compression are typically applied in the process. After the initial replication, an agent monitors the replicated resources for changes. Once a change event occurs, it either sends the change to the ADN immediately (if the system is configured to use continuous data protection), or the change is marked in a local cache and will be sent to the ADN later at specific intervals when operating in the mode of periodical data backup. When the ADN receives the delta changes, the changes are saved to a cloud-based storage system along with metadata such as time and date, account information, file information, among others. Because of the saved metadata, it is possible to reconstruct a “point in time” snapshot of the replicated resources. If for some reason that restore is needed, a customer can select a specific snapshot to restore to.

The system further provides access to the replicated resources via a user interface, typically as part of the web console. Programmatic Application Programming Interfaces (API) can also be made available. Each individual user will be able to access his (or her) own replicated resources and “point in time” replica from the console. From the user interface, system administrators can also manage all replicated resources for an entire organization. Optionally, the system can provide search and indexing services so that users can easily find and locate specific data from the archived resources.

The benefits of the above data protection and archiving system include one or more of the following. The archived resources are available anywhere as along as proper security credentials are met, either via a user interface or via programmatic API. Comparing to traditional backup and archiving solutions, the subject system requires no special hardware or storage system. It is a network delivered service and it is easy to set up. Unlike traditional methods that may require shipping and storing physical disks and tapes, the subject system is easy to maintain and easy to manage. Unlike traditional methods, the subject invention requires no up front investment. Further, the subject system enables customers to “pay as you go” and pay for what they actually use, eliminating wasteful spending typically associated with traditional methods.

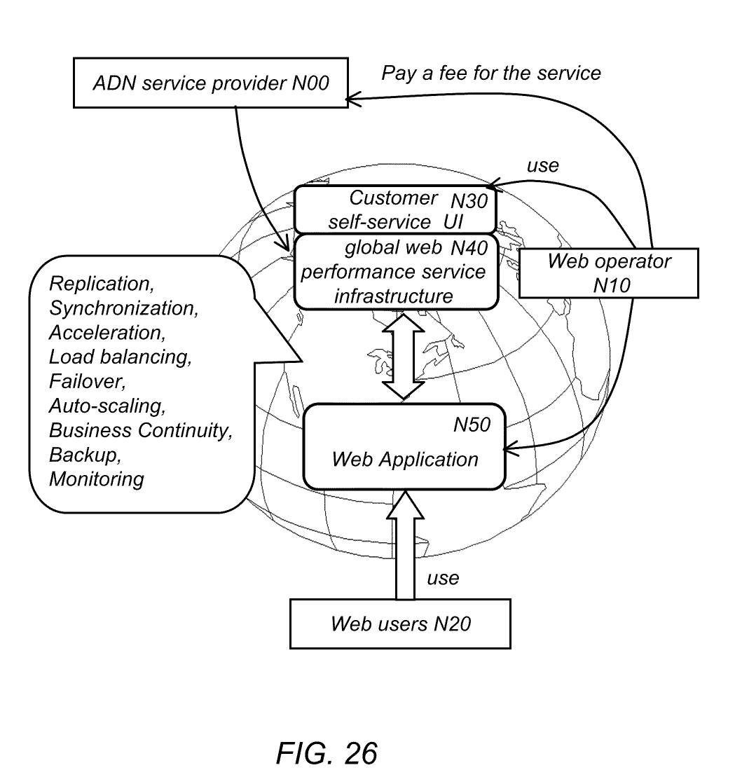

Still another embodiment of the present invention is to provide an on-demand service delivered over the Internet to web operators to help them improve their web application performance, scalability and availability, as shown in FIG. 26. Service provider N00 manages and operates a global infrastructure N40 providing services including monitoring, acceleration, load balancing, traffic management, data backup, replication, data synchronization, disaster recovery, auto scaling and failover. The global infrastructure also has a management and configuration user interface (UI) N30, for customers to purchase, configure and manage services from the service provider. Customers include web operator N10, who owns and manages web application N50. Web application N50 may be deployed in one data center, a few data centers, in one location, in multiple locations, or run on virtual machines in a distributed cloud computing environment. Some of the infrastructure for web application N50 may be owned, or managed by web operator N10 directly. System N40 provides services including monitoring, acceleration, traffic management, load balancing, data synchronization, data protection, business continuity, failover and auto-scaling to web application N50 with the result of better performance, better scalability and better availability to web users N20. In return for using the service, web operator N10 pays a fee to service provider N00.

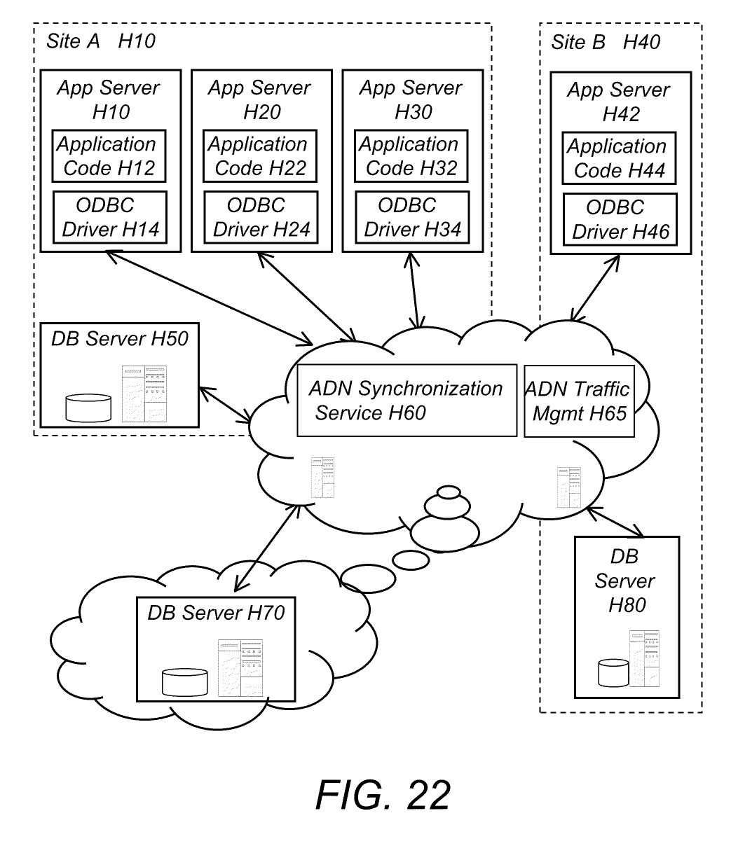

Yet another embodiment of the present invention is a system and method for data synchronization. FIG. 22 shows such a system delivered as a network based service. A common bottleneck for distributed applications is at the data layer, in particular, database access. The problem becomes even worse if the application is running at different data centers and requires synchronization between multiple data centers. The system provides a distributed synchronization service that enables “scale out” capability by just adding more database servers. Further, the system enables an application to run at different data centers with full read and write access to databases, though such databases maybe distributed at different locations over the network.

Referring to FIG. 22, the application is running at two different sites, Site A (H10) and Site B (H40). These two sites can be geographically separated. Multiple application servers are running at Site A, including H10, H20 and H30. At least one application server is running at Site B, H40. Each application server runs the application code that requires “read and write” access to a common set of data. In prior art synchronization systems, these data must be stored in one master database and managed by one master database server. Performance in these prior art systems would be unacceptable because only one master database is allowed and long distance read or write operation can be very slow. The subject invention solves the problem by adding a data synchronization layer and thus eliminates the bottleneck of having only one master database. With the subject invention, an application can have multiple database servers and each of them manages a mirrored set of data, which is kept in synchronization by the synchronization service.

In FIG. 22, the application uses three database servers. H80 is located at Site A, H80 is located at Site B and H70 is located in the cloud. Applications typically use database drivers for database access. Database drivers are program libraries designed to be included in application programs to interact with database servers for database access. Each database in the market, such as MySQL, Oracle, DB2 and Microsoft SQL Server, provides a list of database drivers for a variety of programming languages. FIG. 22 shows four database drivers, H14, H24, H34 and H46. These can be any standard database drivers the application code is using and no change is required.

When a database driver receives a database access request from the application code, it translates the request into a format understood by the target database server, and then sends the request to the network. In the prior art systems, this request will be received and processed by the target database server directly. In the subject invention, the request is routed to the data synchronization service instead. When the operation is a “read” operation, the data synchronization layer either fulfills the request from its local cache, or selects an “optimal” database server to fulfill the request (and subsequently caches the result). If the operation is a “write” operation (an operation that introduces changes to the database), the data synchronization service sends the request to all database servers so all of them perform this operation. Note that a response can be returned as long as one database server finished the “write” operation. There is no need to wait for all database servers to finish the “write” operation. As a result, the application code does not experience any performance penalty. In fact, it would see significant performance gain before of caching and the work load may be spread among multiple database servers.

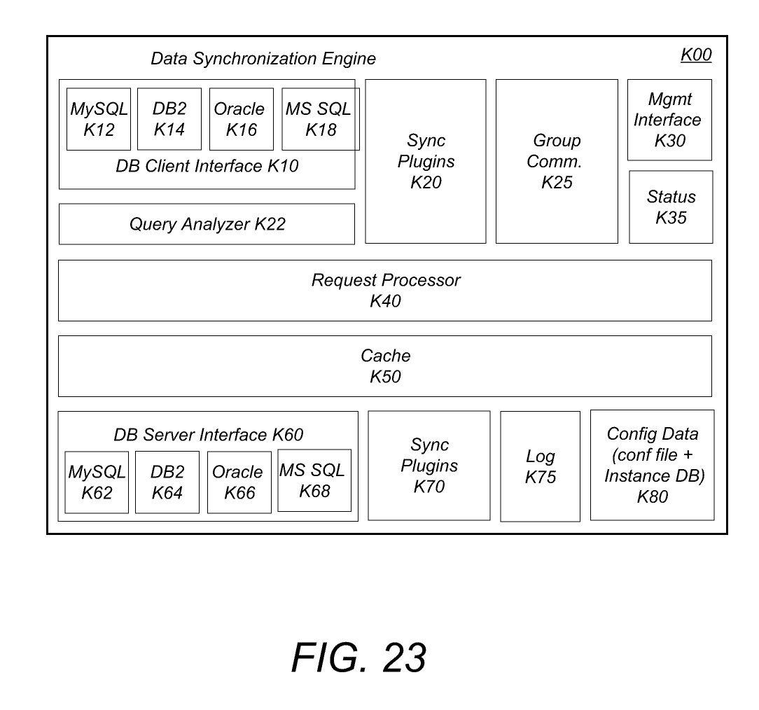

The data synchronization service is fulfilled by a group of nodes in the application delivery network, each of which runs a data synchronization engine. The data synchronization engine is responsible for performing data synchronization among the multiple database servers. Referring to FIG. 23, a data synchronization engine (K00) includes a set of DB client interface modules such as MySql module K12 and DB2 module K14. Each of these modules receives requests from a corresponding type of database driver from the application code. Once a request is received, it is analyzed by the query analyzer K22, and further processed by Request Processor K40. The request processor first checks to see if the request can be fulfilled from its local cache K50. If so, it fulfills the request and returns. If not, it sends the request to the target database servers via an appropriate database driver in the DB Server Interface K60. Once a response is received from a database server, the engine K00 may cache the result, and returns the result to the application code.

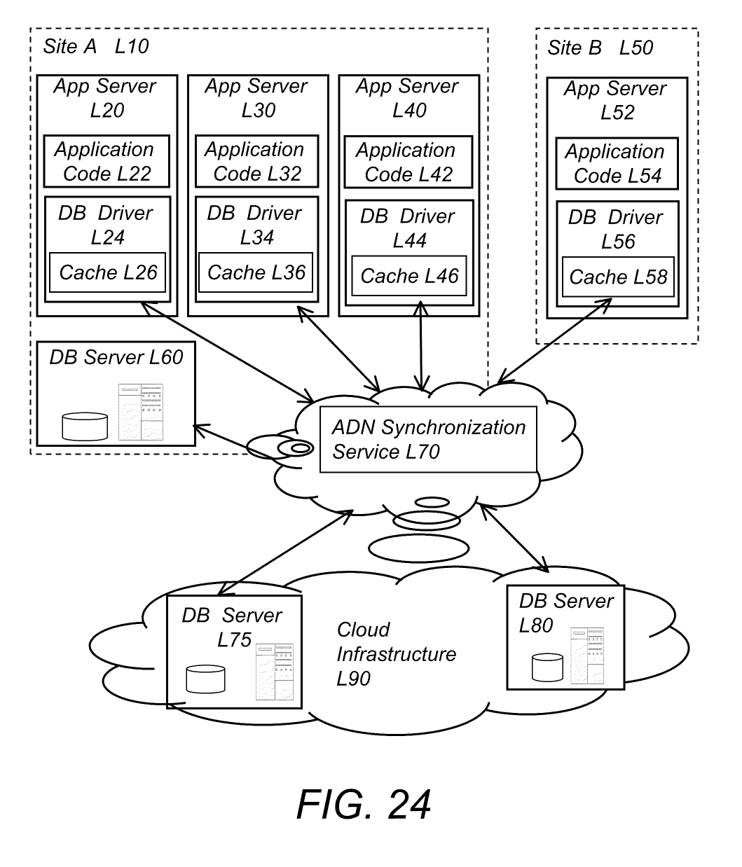

FIG. 24 shows a different implementation of the data synchronization service. The standard database drivers are replaced by special customer database drivers, such as L24, L34, L44 and L56. Each custom database driver behaves identical to a standard DB driver except for add-on intelligence built-in to interact with ADN data synchronization service. Each custom database driver contains its own cache and communicates with Synchronization Service L70 directly to fulfill DB access requests.

The benefits of the subject data synchronization system includes one or more of the following. Significant performance improvement is achieved compared to using only a single database system in a distributed, multi-server or multi-site environment. Horizontal scalability is achieved, i.e., more capacities can be added to the application's data access layer by just adding more database server nodes. The system provides data redundancy because it creates and synchronizes multiple replicas of the same data. If somehow one database failed or corrupted, data is still available from to other database servers. No changes to the existing application code or existing operations are required. It is very easy to use the service and manage the service.

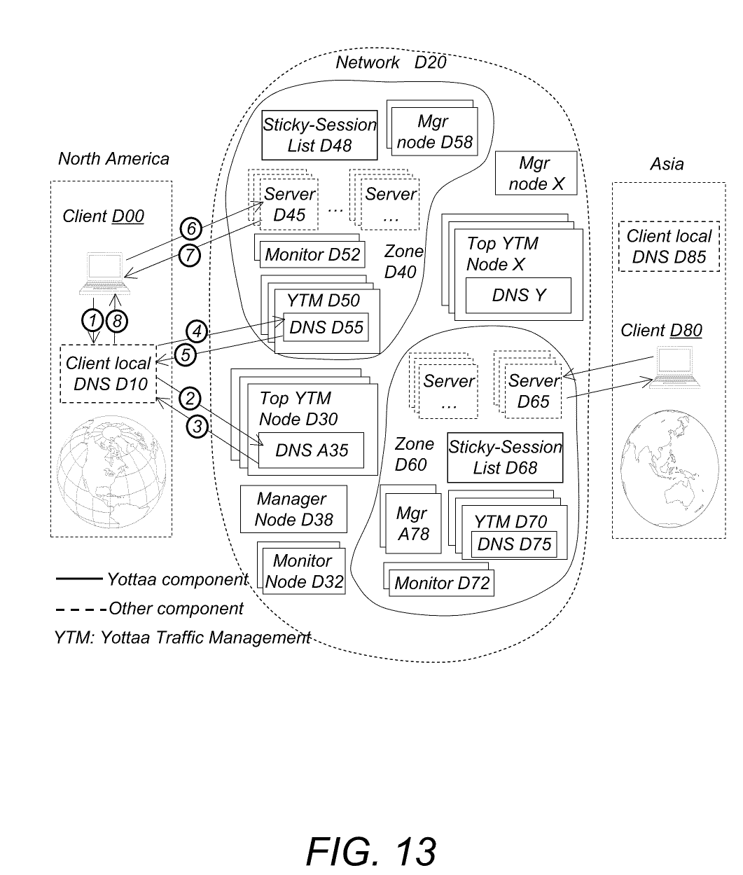

The subject invention is better understood by examining one of its embodiments called “Yottaa” in more detail, shown in FIG. 13. Yottaa is an example of the network delivered service depicted in FIG. 26. It provides a list of services to web applications including:

1. Traffic Management and Load Balancing

2. Performance acceleration

3. Data backup

4. Data synchronization

5. System replication and restore

6. Business continuity and disaster recovery

7. Failover

8. On-demand scaling

9. Monitoring

The system is deployed over network D20. The network can be a local area network, a wireless network, a wide area network such as the Internet, among others. The application is running on nodes labeled as “server”, such as Server D45, Server D65 and so on. Yottaa divides all these server instances into different zones, often according to geographic proximity or network proximity. Over the network, Yottaa deploys several types of nodes including:
1. Yottaa Traffic Management (YTM) nodes, such as D30, D50, and D70. Each YTM node manages a list of server nodes. For example, YTM node D50 manages servers in Zone D40, such as Server D45.
2. Yottaa Manager node, such as D38, D58 and D78.
3. Yottaa Monitor node, such as D32, D52 and D72.

Note that these three types of logical nodes are not required to be implemented as separate entities in actual implementation. Two of then, or all of them, can be combined into the same physical entity.

There are two types of YTM nodes: top level YTM node (such as D30) and lower level YTM node (such as D50 and D70). They are structurally identical but function differently. Whether an YTM node is a top level node or a lower level node is specified by the node's own configuration.

Each YTM node contains a DNS module. For example, YTM D50 contains DNS D55. Further, if a hostname requires sticky-session support (as specified by web operators), a sticky-session list (such as D48 and D68) is created for the hostname of each application. This sticky session list is shared by YTM nodes that manage the same list of server nodes for this application.

In some sense, top level YTM nodes provides service to lower level YTM nodes by directing DNS requests to them and so on. In a cascading fashion, each lower level YTM node may provide similar services to its own set of “lower” level YTM nodes, establishing a DNS tree. Using such a cascading tree structure, the system prevents a node from being overwhelmed with too many requests, guarantees the performance of each node and is able to scale up to cover the entire Internet by just adding more nodes.

FIG. 13 shows architecturally how a client in one geographic region is directed to a “closest” server node. The meaning of “closest” is determined by the system's routing policy for the specific application. When client D00 wants to connect to a server, the following steps happen in resolving the client DNS request:
1. Client D00 sends a DNS lookup request to its local DNS server D10;
2. Local DNS server D10 (if it can not resolve the request directly) sends a request to a top level YTM D30 (actually, the DNS module D35 running inside D30). The selection of D30 is because YTM D30 is configured in the DNS record for the requested hostname;
3. Upon receiving the request from D10, top YTM D30 returns a list of lower level YTM nodes to D10. The list is chosen according to the current routing policy, such as selecting 3 YTM nodes that are geographically closest to client local DNS D10;
4. D10 receives the response, and sends the hostname resolution request to one of the returned lower level YTM nodes, D50;
5. Lower level YTM node D50 receives the request, returns a list of IP addresses of server nodes selected according to its routing policy. In this case, server node D45 is chosen and returned because it is geographically closest to the client DNS D10;
6. D10 returns the received list of IP addresses to client D00;
7. D00 connects to server D45 and sends a request;
8. Server D45 receives the request from client D00, processes it and returns a response.

Similarly, client D80 who is located in Asia is routed to server D65 instead.

As shown in FIG. 5, the subject invention provides a web-based user interface (UI) for web operators to configure the system. Web operators can also use other means such as making network-based Application Programming Interface (API) calls or modifying configuration files directly by the service provider. Using Web UI as an example, a web operator would:
1. Enter the hostname of the target web application, for example, www.yottaa.com;
2. Enter the IP addresses of the static servers that the target web application is currently running on (the “origin site” information);
3. Configure whether the system is allowed to launch new server instances in response to traffic spikes and the associated node management policy. Also, whether the system is allowed to shut down server nodes if capacity exceeds demand by a certain threshold;
4. Add the supplied top level Traffic Management node names to the DNS record of the hostname of the target application;
5. Configure replication services, such as data replication policy;
6. Configure data synchronization services (if needed for this application). Note that data synchronization service is only needed if all application instances must access the same database for “write” operations. A variety of applications do not need data synchronization service;
7. Configure business continuity service;
8. Configure other parameters such as whether the hostname requires sticky-session support, session expiration value, routing policy, and so on.

Once the system receives the above information, it performs necessary actions to set up its service. For example, in the Yottaa embodiment, upon receiving the hostname and static IP addresses of the target server nodes, the system propagates such information to selected lower level YTM nodes (using the current routing policy) so that at least some lower level YTM nodes can resolve the hostname to IP address(s) when a DNS lookup request is received. Another example is that it activates agents on the various hosts to perform initial replication.

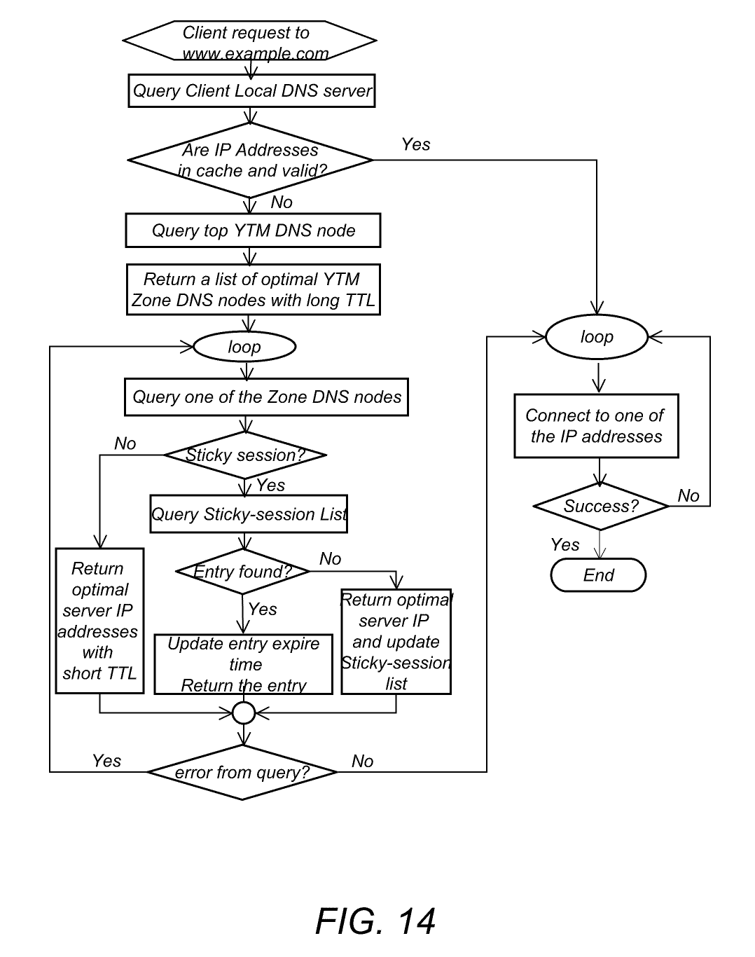

FIG. 14 shows a process workflow of how a hostname is resolved using the Yottaa service. When a client wants to connect to a host, i.e., www.example.com, it needs to resolve the IP address of the hostname first. To do so, it queries its local DNS server. The local DNS server first checks whether such a hostname is cached and still valid from a previous resolution. If so, the cached result is returned. If not, client DNS server issues a request to the pre-configured DNS server for www.example.com, which is a top level YTM node. The top level YTM node returns a list of lower level YTM nodes according to a repeatable routing policy configured for this application. For example, the routing policy can be related to the geo-proximity between the lower level YTM node and the client DNS server A10, a pre-computed mapping between hostnames and lower level YTM nodes, or some other repeatable policy. Whatever policy is used, the top level YTM node guarantees the returned result is repeatable. If the same client DNS server requests the same hostname resolution again later, the same list of lower level YTM nodes is returned. Upon receiving the returned list of YTM nodes, client DNS server needs to query these nodes until a resolved IP address is received. So it sends a request to one of the lower level YTM nodes in the list. The lower level YTM receives the request. First, it figures out whether this hostname requires sticky-session support. Whether a hostname requires sticky-session support is typically configured by the web operator during the initial setup of the subscribed Yottaa service (can be changed later). If sticky-session support is not required, the YTM node returns a list of IP addresses of “optimal” server nodes that are mapped to www.example.com, chosen according to the current routing policy.

If sticky-session support is required, the YTM node first looks for an entry in the sticky-session list using the hostname (in this case, www.example.com) and the IP address of the client DNS server as the key. If such an entry is found, the expiration time of this entry in the sticky-session list is updated to be the current time plus the pre-configured session expiration value. When a web operator performs initial configuration of Yottaa service, he enters a session expiration timeout value into the system, such as one hour. If no entry is found, the YTM node picks an “optimal” server node according to the current routing policy, creates an entry with the proper key and expiration information, and inserts this entry into the sticky-session list. Finally, the server node's IP address is returned to the client DNS server. If the same client DNS server queries www.example.com again before the entry expires, the same IP address will be returned.

If an error is received during the process of querying a lower level YTM node, the client DNS server will query the next YTM node in the list. So the failure of an individual lower level YTM node is invisible to the client. Finally, the client DNS server returns the received IP address(s) to the client. The client can now connect to the server node. If there is an error connecting to a returned IP address, the client will try to connect to the next IP address in the list, until a connection is successfully made.

Top YTM nodes typically set a long Time-to-live (TTL) value for its returned results. Doing so minimizes the load on top level nodes as well as reduces the number of queries from the client DNS server. On the other side, lower YTM nodes typically set a short Time-to-live value, making the system very responsive to node status changes.

The sticky-session list is periodically cleaned up by purging the expired entries. An entry expires when there is no client DNS request for the same hostname from the same client DNS server during the entire session expiration duration since the last lookup. Further, web operators can configure the system to map multiple (or using a wildcard) client DNS servers to one entry in the sticky-session table. In this case, DNS query from any of these client DNS servers receives the same IP address for the same hostname when sticky-session support is required.

During a sticky-session scenario, if the server node of a persistent IP address goes down, a monitor node detects the server failure, notifies its associated manager nodes. The associated manager nodes notify the corresponding YTM nodes. These YTM nodes then immediately remove the entry from the sticky-session list, and direct traffic to a different server node. Depending on the returned Time-to-live value, the behavior of client DNS resolvers and client DNS servers, and how the application is programmed, users who were connected to the failed server node earlier may see errors duration the transition period. However, the impact is only visible to this portion of users during a short period of time. Upon TTL expiration, which is expected to be short given that lower level YTM nodes set short TTL, these users will connect to a different server node and resume their operations. Further, for sticky-session scenarios, the system manages server node shutdown intelligently so as to eliminate service interruption for these users who are connected to this server node. It waits until all user sessions on this server node have expired before finally shutting down the node instance.

Yottaa leverages the inherit scalability designed into the Internet's DNS system. It also provides multiple levels of redundancy in every step, except for sticky-session scenarios where a DNS lookup requires a persistent IP address. Further, the system uses a multi-tiered DNS hierarchy so that it naturally spreads loads onto different YTM nodes to efficiently distribute load and be highly scalable, while be able to adjust TTL value for different nodes and be responsive to node status changes.

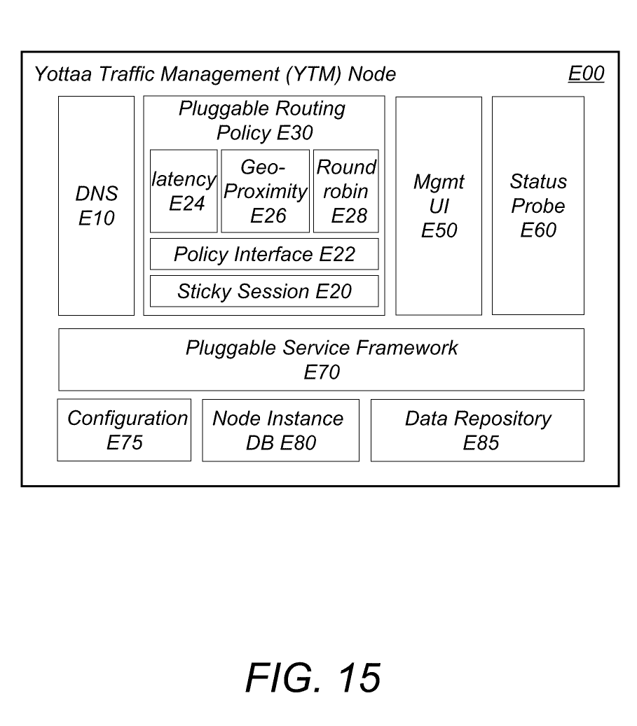

FIG. 15 shows the functional blocks of a Yottaa Traffic Management node E00. The node E00 contains DNS module E10 that perform standard DNS functions, status probe module E60 that monitors status of this YTM node itself and responds to status inquires, management UI module E50 that enables system administrators to manage this node directly when necessary, node manager E40 (optional) that can manage server nodes over a network and a routing policy module E30 that manages routing policy. The routing policy module can load different routing policy as necessary. Part of module E30 is an interface for routing policy and another part of this module provide sticky-session support during a DNS lookup process. Further, YTM node E00 contains configuration module E75, node instance DB E80, and data repository module E85.

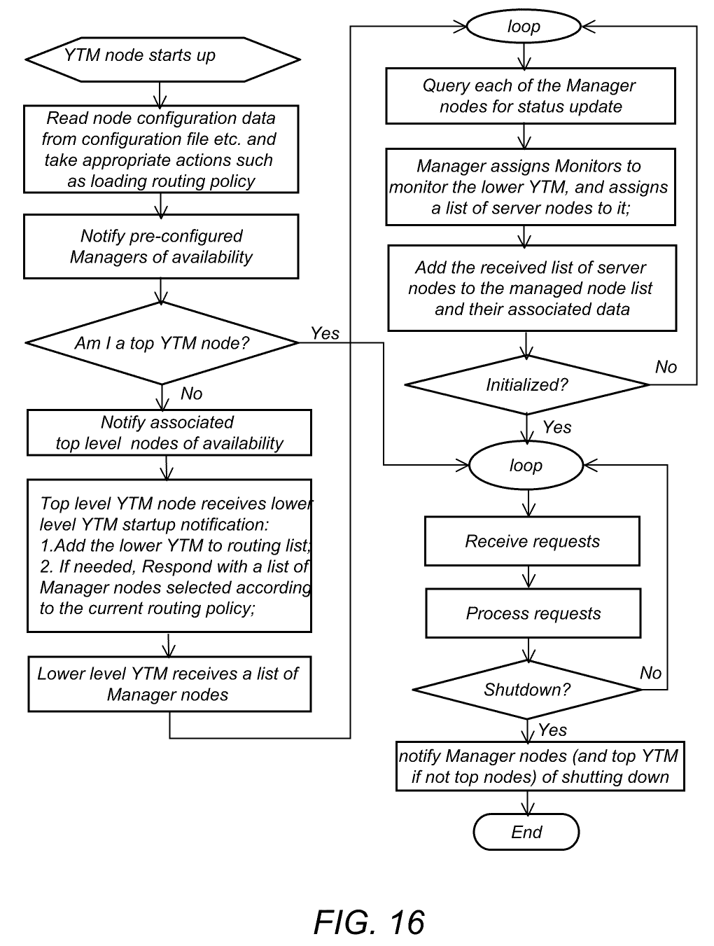

FIG. 16 shows how an YTM node works. When an YTM node boots up, it reads initialization parameters from its environment, its configuration file and instance DB among others. During the process, it takes proper actions as necessary, such as loading specific routing policies for different applications. Further, if there are managers specified in the initialization parameters, the node sends a startup availability event to such managers. Consequentially, these managers propagate a list of server nodes to this YTM node and assign monitors to monitor the status of this YTM node. Then the node checks to see if it is a top level YTM according to its configuration parameters. If it is a top level YTM, the node enters its main loop of request processing until eventually a shutdown request is received or a node failure happened. Upon receiving a shutdown command, the node notifies its associated managers of the shutdown event, logs the event and then performs shutdown. If the node is not a top level YTM node, it continues its initialization by sending a startup availability event to a designated list of top level YTM nodes as specified in the node's configuration data.

When a top level YTM node receives a startup availability event from a lower level YTM node, it performs the following actions:
1. Adds the lower level YTM node to the routing list so that future DNS requests maybe routed to this lower level YTM node;
2. If the lower level YTM node does not have associated managers set up already (as indicated by the startup availability event message), selects a list of managers according to the top level YTM node's own routing policy, and returns this list of manager nodes to the lower level YTM node.

When a lower level YTM node receives the list of managers from a top level YTM node, it continues its initialization by sending a startup availability event to each manager in the list. When a manager node receives a startup availability event from a lower level YTM node, it assigns monitor nodes to monitor the status of the YTM node. Further, the manager returns the list of server nodes that is under management by this manager to the YTM node. When the lower level YTM node receives a list of server nodes from a manager node, the list is added to the managed server node list that this YTM node manages so that future DNS requests maybe routed to servers in the list.

After the YTM node completes setting up its managed server node list, it enters its main loop for request processing. For example:
If a DNS request is received, the YTM node returns one or more server nodes from its managed server node list according to the routing policy for the target hostname and client DNS server.
If the request is a server node down event from a manager node, the server node is removed from the managed server node list.
If a server node startup event is received, the new server node is added to the managed server node list.

Finally, if a shutdown request is received, the YTM node notifies its associated manager nodes as well as the top level YTM nodes of its shutdown, saves the necessary state into its local storage, logs the event and shuts down.

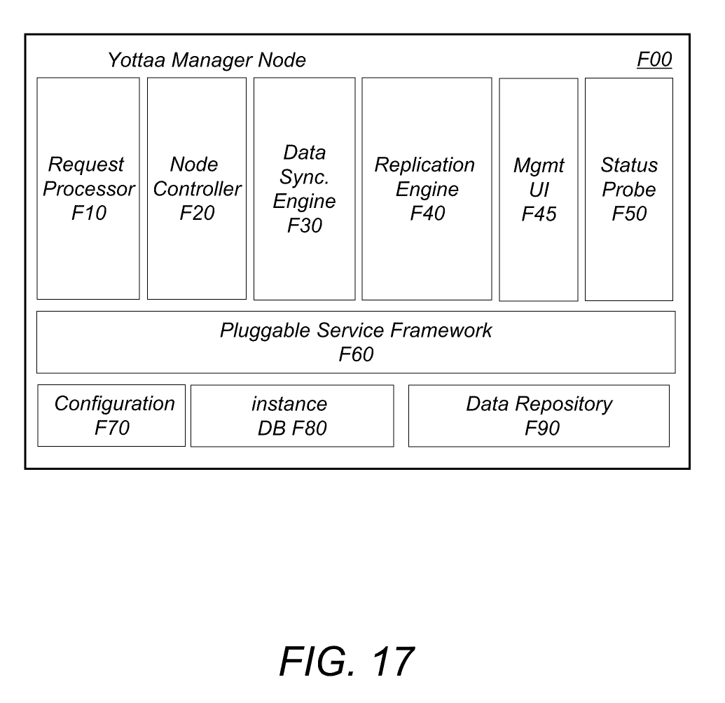

Referring to FIG. 17, a Yottaa manager node F00 includes a request processor module F10 that processes requests received from other nodes over the network, a node controller module F20 that can be used to manage virtual machine instances, a management user interface (UI) module F45 that can be used to configure the node locally, and a status probe module F50 that monitors the status of this node itself and responds to status inquires. Optionally, if a monitor node is combined into this node, the manager node then also contains a node monitor which maintains the list of nodes to be monitored and periodically polls nodes in the list according to the current monitoring policy. Note that Yottaa manager node F00 also contains data synchronization engine F30 and replication engine F40. One is for data synchronization service and the other one is for replication service. More details of data synchronization engine is shown in FIG. 23.

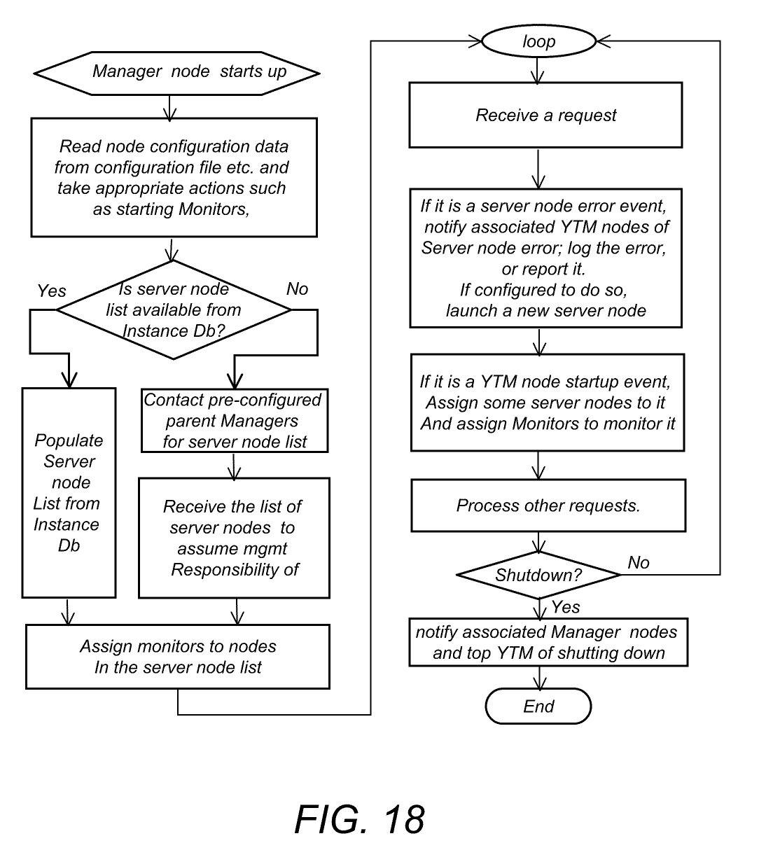

FIG. 18 shows how a Manager node works. When it starts up, it reads configuration data and initialization parameters from its environment, configuration file and instance DB, among others. Proper actions are taken during the process. Then it sends a startup availability event to a list of parent managers as specified from its configuration data or initialization parameters. When a parent manager receives the startup availability event, it adds this new node to its list of nodes under “management”, and “assigns” some associated monitor nodes to monitor the status of this new node by sending a corresponding request to these monitor nodes. Then the parent manager delegates the management responsibilities of some server nodes to the new manager node by responding with a list of such server nodes. When the child manager node receives a list of server nodes of which it is expected to assume management responsibility, it assigns some of its associated monitors to do status polling, performance monitoring of the list of server nodes. If no parent manager is specified, the Yottaa manager is expected to create its list of server nodes from its configuration data. Then the manager node finishes its initialization and enters its main processing loop of request processing. If the request is a startup availability event from an YTM node, it adds this YTM node to the monitoring list and replies with the list of server nodes for which it assigns the YTM node to do traffic management. Note that, in general, the same server node is assigned to multiple YTM nodes for routing. If the request is a shutdown request, it notifies its parent managers of the shutdown, logs the event, and then performs shutdown. If a node error request is reported from a monitor node, the manager removes the error node from its list (or move it to a different list), logs the event, and optionally reports the event. If the error node is a server node, the manager node notifies the associated YTM nodes of the server node loss, and if configured to do so and a certain conditions are met, attempts to re-start the node or launch a new server node.

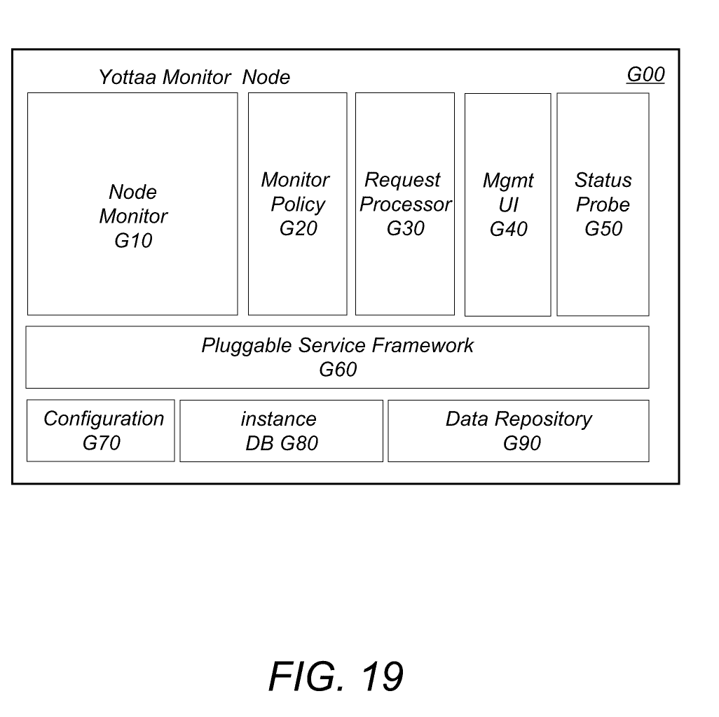

Referring to FIG. 19, Yottaa monitor node G00 includes a node monitor G10, monitor policy G20, request processor G30, management UI G40, status probe G50, pluggable service framework G60, configuration G70, instance DB G80 and data repository G90. Its basic functionality is to monitor the status and performance of other nodes over the network.

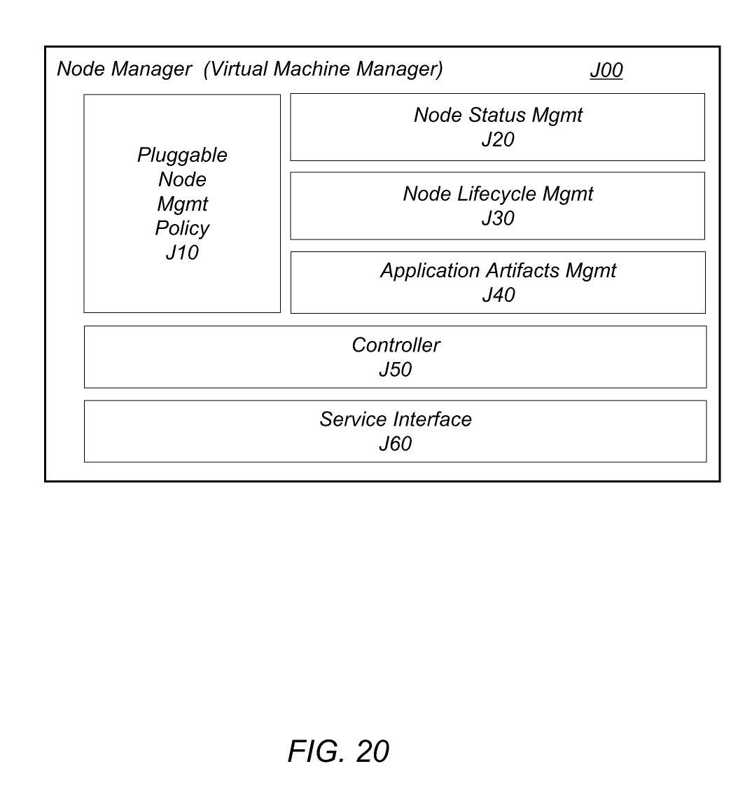

Referring to FIG. 20, node controller module J00 includes pluggable node management policy J10, node status management J20, node lifecycle management J30, application artifacts management J40, controller J50, and service interface J60. Node controller (manager) J00 provides service to control nodes over the network, such as starting and stopping virtual machines. An important part is the node management policy J10. A node management policy is created when the web operator configures the system for an application by specifying whether the system is allowed to dynamically start or shut down nodes in response to application load condition changes, the application artifacts to use for launching new nodes, initialization parameters associated with new nodes, and so on. Per the node management policy in the system, the node management service calls node controllers to launch new server nodes when the application is overloaded and shut down some server nodes when it detects these nodes are not needed any more. As stated earlier, the behavior can be customized using either the management UI or via API calls. For example, a web operator can schedule a capacity scale-up to a certain number of server nodes (or to meet a certain performance metric) in anticipation of an event that would lead to significant traffic demand.

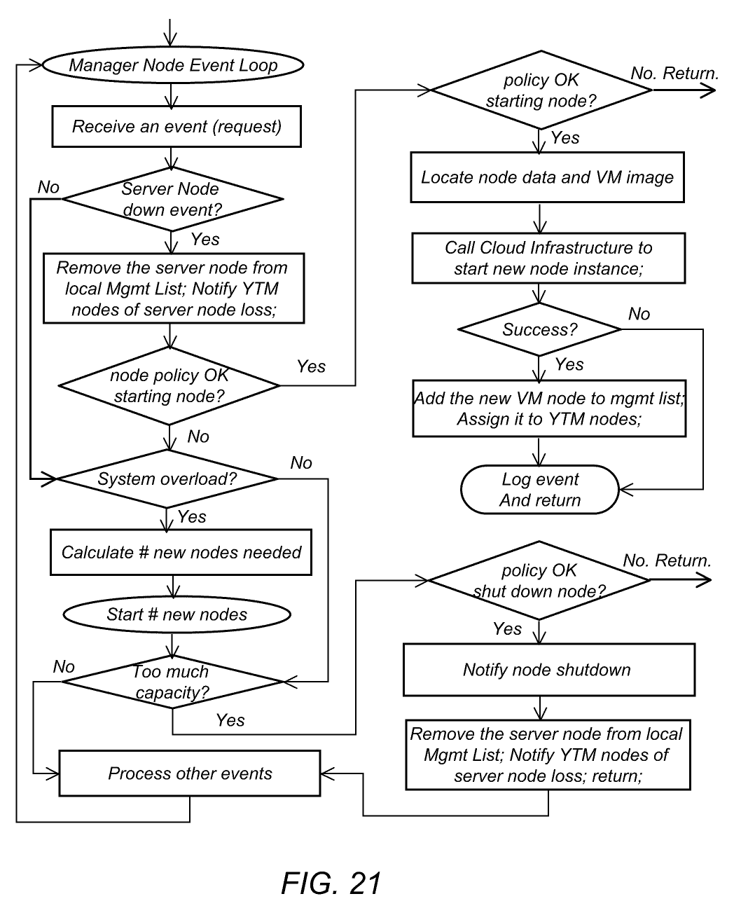

FIG. 21 shows the node management workflow. When the system receives a node status change event from its monitoring agents, it first checks whether the event signals a server node down. If so, the server node is removed from the system. If the system policy says “re-launch failed nodes”, the node controller will try to launch a new server node. Then the system checks whether the event indicates that the current set of server nodes are getting overloaded. If so, at a certain threshold, and if the system's policy permits, a node manager will launch new server nodes and notify the traffic management service to spread load to the new nodes. Finally, the system checks to see whether it is in the state of “having too much capacity”. If so and the node management policy permits, a node controller will try to shut down a certain number of server nodes to eliminate capacity waste. In launching new server nodes, the system picks the best geographic region to launch the new server node. Globally distributed cloud environments such as Amazon.com's EC2 cover several continents. Launching new nodes at appropriate geographic locations help spread application load globally, reduce network traffic and improve application performance. In shutting down server nodes to reduce capacity waste, the system checks whether session stickiness is required for the application. If so, shutdown is timed until all current sessions on these server nodes have expired.

Several embodiments of the present invention have been described. Nevertheless, it will be understood that various modifications may be made without departing from the spirit and scope of the invention. Accordingly, other embodiments are within the scope of the following claims.

What is claimed is:

1. A method for improving the performance and availability of a distributed application comprising:
providing a distributed application configured to run on one or more origin server nodes located at an origin site;
providing a networked computing environment comprising one or more server nodes, wherein said origin site and said computing environment are connected via a network;
providing replication means configured to replicate said distributed application;
replicating said distributed application via said replication means thereby generating one or more replicas of said distributed application;
providing node management means configured to control any of said server nodes;
deploying said replicas of said distributed application to one or more server nodes of said computing environment via said node management means;
providing traffic management means configured to direct client requests to any of said server nodes; and
directing client requests targeted to access said distributed application to optimal server nodes running said distributed application via said traffic management means, wherein said optimal server nodes are selected among said origin server nodes and said computing environment server nodes based on certain metrics.

2. The method of claim 1, wherein said networked computing environment comprises a cloud computing environment.

3. The method of claim 1, wherein said networked computing environment comprises virtual machines.

4. The method of claim 1, wherein said server nodes comprise virtual machine nodes.

5. The method of claim 4, wherein said node management means control any of said server nodes by starting a new virtual machine node.

6. The method of claim 4, wherein said node management means control any of said server nodes by shutting down an existing virtual machine node.

7. The method of claim 1, wherein said replication means replicate said distributed application by generating virtual machine images of a machine on which said distributed application is running at said origin site.

8. The method of claim 1, wherein said replication means is further configured to copy resources of said distributed application.

9. The method of claim 8, wherein said resources comprise one of application code, application data, or an operating environment in which said distributed application runs.

10. The method of claim 1, wherein said traffic management means comprises means for resolving a domain name of said distributed application via a Domain Name Server (DNS).

11. The method of claim 1, wherein said traffic management means performs traffic management by providing IP addresses of said optimal server nodes to clients.

12. The method of claim 1, wherein said traffic management means comprises one or more hardware load balancers.

13. The method of claim 1, wherein said traffic management means comprises one or more software load balancers.

14. The method of claim 1, wherein said traffic management means performs load balancing among said server nodes in said origin site and said computing environment.

15. The method of claim 1, wherein said certain metrics comprise geographic proximity of said server nodes to said client.

16. The method of claim 1, wherein said certain metrics comprise load condition of a server node.

17. The method of claim 1, wherein said certain metrics comprise network latency between a client and a server node.

18. The method of claim 1, further comprising providing data synchronization means configured to synchronize data among said server nodes.

19. The method of claim 1, wherein said replication means provides continuous replication of changes in said distributed application and wherein said changes are deployed to server nodes where said distributed application has been previously deployed.

20. A system for improving the performance and availability of a distributed application comprising:
a distributed application configured to run on one or more origin server nodes located at an origin site;
a networked computing environment comprising one or more server nodes, wherein said origin site and said computing environment are connected via a network;
replication means configured to replicate said distributed application, and wherein said replication means replicate said distributed application and thereby generate one or more replicas of said distributed application;
node management means configured to control any of said server nodes, and wherein said node management means deploy said replicas of said distributed application to one or more server nodes of said computing environment;
traffic management means configured to direct client requests to any of said server nodes and wherein said traffic management means direct client requests targeted to access said distributed application to optimal server nodes running said distributed application, and wherein said optimal server nodes are selected among said origin server nodes and said computing environment server nodes based on certain metrics.

21. The system of claim 20, wherein said networked computing environment comprises a cloud computing environment.

22. The system of claim 20, wherein said networked computing environment comprises virtual machines.

23. The system of claim 20, wherein said server nodes comprise virtual machine nodes.

24. The system of claim 23, wherein said node management means control any of said server nodes by starting a new virtual machine node.

25. The system of claim 23, wherein said node management means control any of said server nodes by shutting down an existing virtual machine node.

26. The system of claim 20, wherein said replication means replicate said distributed application by generating virtual machine images of a machine on which said distributed application is running at said origin site.

27. The system of claim 20, wherein said replication means is further configured to copy resources of said distributed application.

28. The system of claim 27, wherein said resources comprise one of application code, application data, or an operating environment in which said distributed application runs.

29. The system of claim 20, wherein said traffic management means comprises means for resolving a domain name of said distributed application via a Domain Name Server (DNS).

30. The system of claim 20, wherein said traffic management means performs traffic management by providing IP addresses of said optimal server nodes to clients.

31. The system of claim 20, wherein said traffic management means comprises one or more hardware load balancers.

32. The system of claim 20, wherein said traffic management means comprises one or more software load balancers.

33. The system of claim 20, wherein said traffic management means performs load balancing among said server nodes in said origin site and said computing environment.

34. The system of claim 20, wherein said certain metrics comprise geographic proximity of said server nodes to said client.

35. The system of claim 20, wherein said certain metrics comprise load condition of a server node.

36. The system of claim 20, wherein said certain metrics comprise network latency between a client and a server node.

37. The system of claim 20, further comprising data synchronization means configured to synchronize data among said server nodes.

38. The system of claim 20, wherein said replication means provides continuous replication of changes in said distributed application and wherein said changes are deployed to server nodes where said distributed application has been previously deployed.
